(19) United States
(12) Patent Application Publication
(10) Pub. No.: US 2017/0329180 A1
(43) Pub. Date: Nov. 16, 2017

(54) LIGHTING DEVICE, DISPLAY DEVICE, AND TELEVISION DEVICE

(71) Applicant: Sharp Kabushiki Kaisha, Sakai City, Osaka (JP)

(72) Inventors: YOSHINOBU HIRAYAMA, Sakai City (JP); TAKAO IMAOKU, Sakai City (JP); SHUGO YAGI, Yonago-shi (JP)

(21) Appl. No.: 15/532,364

(22) PCT Filed: Nov. 26, 2015
(86) PCT No.: PCT/JP2015/083165

§ 371 Date: Jun. 1, 2017

(30) Foreign Application Priority Data
Dec. 3, 2014 (JP) 2014-244807

(51) Int. Cl. G02F 1/1335; F21V 8/00

(52) U.S. Cl. CPC G02F 1/133602; G02B 6/0073; G02B 6/0025; G02B 6/0055

(57) ABSTRACT

A lighting device includes LEDs 17, a light guide plate 19 including an edge surface and a pair of plate surfaces, a light reflection sheet 40, and a wavelength conversion sheet 50. A part of the edge surface is a light entrance surface 19B through which light from the LEDs 17 enters, and the pair of plate surfaces are light exit surfaces 19A, 19C through which the light exits. The light guide plate 19 includes second prism portions 65 formed on the light exit surface 19A and configured to collect light in a direction of a normal line of the light exit surface 19A. The light reflection sheet 40 is disposed to cover the light exit surface 19C reflects the light in a direction toward the light guide plate 19. The wavelength conversion sheet 50 is disposed between the light guide plate 19 and the light reflection sheet 40 and converts a wavelength of light transmitting therethrough.

### TECHNICAL FIELD

The present invention relates to a lighting device, a display device, and a television device.

### BACKGROUND ART

An example of a backlight unit included in a display device is disclosed in Patent Document 1. The backlight unit disclosed in Patent Document 1 includes a light source and a light guide film, and a quantum film (QD film) containing quantum dots is between the light source and the light guide film to cover the light guide film. A part of blue light emitted by a blue LED that is a light source is converted into red light and green light by the QD film and light of three colors is mixed and white light is generated. The backlight unit of Patent Document 1 includes two prism films that cover the QD film. According to such a configuration, light transmitting through the QD film is dispersed and collected by the prism films and good front luminance is obtained.

### RELATED ART DOCUMENT

### Patent Document

Patent Document 1: Japanese Unexamined Patent Application Publication (Translation of PCT Application) 2013-539598

### Problem to be Solved by the Invention

The lighting device has been required to be reduced in thickness and cost and the number of the prism films (light collection sheets) may be reduced to meet such requirement.

### DISCLOSURE OF THE PRESENT INVENTION

An object of the present invention is to reduce the number of light collection sheets and maintain good front luminance.

### Means for Solving the Problem

To solve the above problem, a lighting device includes light sources, a light guide plate including an edge surface, a pair of plate surfaces, and a light collecting portion, a light reflecting member, and a wavelength conversion member. A part of the edge surface is a light entrance surface through which light from the light sources enters, and the pair of plate surfaces are light exit surfaces through which the light exits, and the light collecting portion is formed on one of the pair of plate surfaces and configured to collect light in a direction of a normal line of the one of the pair of plate surfaces. The light reflecting member is disposed to cover the one of the pair of plate surfaces or another one of the pair of plate surfaces and configured to reflect the light toward the light guide plate, and the wavelength conversion member is disposed between the light guide plate and the light reflecting member and converts a wavelength of light transmitting therethrough.

According to the present invention, light from the light sources enters the light guide plate through the light entrance surface and travels within the light guide plate and exits the light guide plate through the light exit surfaces. The light exiting the light guide plate through the light exit surface 19C (hereinafter, referred to as a first light exit surface) near the light reflection sheet passes through the wavelength conversion member and reflects off the light reflecting member toward the light guide plate. Then, the light passes through the wavelength conversion member again and enters the light guide plate and exits the light guide plate through the light exit surface (hereinafter, referred to as a second light exit surface) that is opposite from the light exit surface near the light reflecting member. Accordingly, the light exiting the light guide plate through the second light exit surface includes light that is emitted by the light sources and travels toward the second light exit surface without passing through the wavelength conversion member (light having wavelength same as that of the light emitted by the light sources) and light that is emitted by the light sources and travels toward the second light exit surface after passing through the wavelength conversion member. According to the present invention, the light guide plate includes a light collection portion on one of the light exit surfaces. Therefore, the light passing through the wavelength conversion member is collected by the light collection portion and exits the light guide plate through the second light exit surface. If the wavelength conversion member is arranged to cover the second light exit surface of the light guide plate, the wavelength conversion member is required to be covered with a light collecting member to collect light passing through the wavelength conversion member. According to the present invention, the wavelength conversion member is between the light guide plate and the light reflection member and the light guide plate includes the light collecting member. According to such a configuration, the light passing through the wavelength conversion member and travels toward the light guide plate can be collected. As a result, the number of the light collecting members is reduced with maintaining good front luminance (luminance seen from the normal direction of the light exit surface).

The light guide plate may have a rectangular shape and the light entrance surface may have an elongated shape extending in one side direction of the light guide plate. The light sources may be arranged in an elongated direction of the light entrance surface. The light collecting portion may collect light with respect to an arrangement direction in which the light sources are arranged. According to such a configuration, the light is collected with respect to the arrangement direction in which the light sources are arranged.

The light collecting portion may include unit light collecting portions that extend in another side direction of the light guide plate and are arranged in the one side direction. The light collecting action is provided by the unit light collecting portions.

One of the pair of light exit surfaces that is covered with the light reflection portion may have inclined surfaces each of which is inclined toward another one of the pair of light exit surfaces that is not covered with the light reflection portion as is farther away from the light sources, and the inclined surfaces may be arranged in a direction farther away from the light sources.

According to such a configuration, a part of the rays of light travelling within the light guide plate is reflected by the inclined surfaces toward the light exit surface without having the light reflection member. As a result, the amount of light travelling in the normal direction of the light exit surface is increased and the front luminance is increased.

The inclined surfaces may have a greater area as is farther away from the light sources. According to such a configuration, a greater amount of light is reflected by the inclined surfaces that are farther from the light sources in a direction toward the light exit surface without having the light reflection member. Generally, the amount of exit light is reduced as a position of the light guide plate is farther away from the light sources. According to the configuration where each area of the inclined surfaces is set as described above, luminance unevenness is less likely to occur in the light exiting through the portion of the light exit surface closer to the light sources and the portion thereof farther away from the light sources.

The lighting device may further include a light collecting sheet provided to cover one of the pair of light exit surfaces that is not covered with the light reflecting member and configured to collect light to travel in a direction of a normal line of the one of the pair of light exit surfaces. According to such a configuration, the light collected by the light collecting portions is further collected by the light collecting sheet. Accordingly, light is collected with respect to the plate surface direction of the light guide plate and the front luminance of the exit light of the lighting device is further increased.

The light collecting sheet may be configured to collect light in a direction along the plate surfaces of the light guide plate and with respect to a direction perpendicular to a light collection direction of the light collection portion. According to such a configuration, the light collected by the light collecting portions is further collected by the light collecting sheet. Accordingly, the light is collected in the plate surface direction of the light guide plate and the front luminance of the exit light of the lighting device is further increased.

The light collecting sheet may be a prism sheet including prism portions, and each of the prism portions may have a triangular cross-sectional shape that narrows toward the light exit surface that is not covered with the light reflecting member.

Next, to solve the above problem, a display device includes the above lighting device and a display panel displaying images using light from the lighting device. According to the display device having such a configuration, the front luminance of exit light from the lighting device is increased and display quality is improved.

The display panel may be a liquid crystal panel including a pair of substrates and liquid crystals enclosed between the substrates. Such a display device may be used as a liquid crystal display device of a display of smartphones or tablet computers.

Next, to solve the above problem, a television device includes the above display device. The television device includes the display device that improves display quality and television images of good display quality can be displayed.

### Advantageous Effect of the Invention

According to the present invention, the number of collection sheets is reduced and good front luminance is maintained.

### BRIEF DESCRIPTION OF THE DRAWINGS

FIG. 1 is an exploded perspective view illustrating a general configuration of a liquid crystal display device according to a first embodiment of the present invention.

FIG. 2 is an exploded perspective view illustrating a general configuration of a backlight device included in the liquid crystal display device.

FIG. 3 is a cross-sectional view illustrating a cross-sectional configuration taken in a long-side direction (X-axis direction) of the backlight device of FIG. 2.

FIG. 4 is a cross-sectional view illustrating a vicinity of a light guide plate in FIG. 3.

FIG. 5 is a cross-sectional view illustrating a cross-sectional configuration taken in a short-side direction (Y-axis direction) of the backlight device in FIG. 2 (taken along line V-V in FIG. 4).

FIG. 6 is a graph illustrating correlation of an apex angle T1 of a second prism portion 65 and front luminance of exit light exiting through a light exit surface 19A.

FIG. 7 is a graph illustrating correlation of an inclination angle K1 of a third inclined surface 63 and front luminance of exit light exiting through the light exit surface 19A.

FIG. 8 is a table illustrating configurations of Comparative Examples 1 and 2 and the first embodiment.

FIG. 9 is a view illustrating a luminance angle distribution of Comparative Example 1.

FIG. 10 is a view illustrating a luminance angle distribution of Comparative Example 2.

FIG. 11 is view illustrating a luminance angle distribution of the first embodiment.

FIG. 12 is an exploded perspective view illustrating a general configuration of a backlight device according to a second embodiment of the present invention.

FIG. 13 is a cross-sectional view illustrating a cross-sectional configuration taken in the X-axis direction of the backlight device in FIG. 12.

FIG. 14 is a cross-sectional view illustrating a cross-sectional configuration taken in the Y-axis direction of the backlight device in FIG. 12 (taken along line XIV-XIV in FIG. 13).

FIG. 15 is a graph illustrating a luminance angle distribution of exit light in Comparative Example 3 and the second embodiment (a luminance angle distribution with respect to the X-axis direction).

FIG. 16 is a graph illustrating a luminance angle distribution of exit light in Comparative Example 3 and the second embodiment (a luminance angle distribution with respect to the Y-axis direction).

FIG. 17 is a cross-sectional view illustrating a cross-sectional configuration taken in the X-axis direction of a backlight device according to a third embodiment of the present invention.

FIG. 18 is a view illustrating a luminance angle distribution of exit light exiting a light guide plate 219 according to Comparative Example 4 (and Comparative Example 5).

FIG. 19 is a view illustrating a luminance angle distribution of exit light exiting a prism sheet according to Comparative Example 4.

FIG. 20 is a view illustrating a luminance angle distribution of exit light exiting a wavelength conversion sheet according to Comparative Example 5.

FIG. 21 is a view illustrating a luminance angle distribution of exit light exiting a prism sheet according to Comparative Example 5.

FIG. 22 is a graph illustrating a luminance angle distribution of exit light according to Comparative Example 5 and the third embodiment (a luminance angle distribution with respect to the X-axis direction).

FIG. 23 is a graph illustrating a luminance angle distribution of exit light according to Comparative Example 5 and the third embodiment (a luminance angle distribution with respect to the Y-axis direction).

FIG. 24 is an exploded perspective view illustrating a general configuration of a television device according to a fourth embodiment of the present invention.

### MODES FOR CARRYING OUT THE INVENTION

### First Embodiment

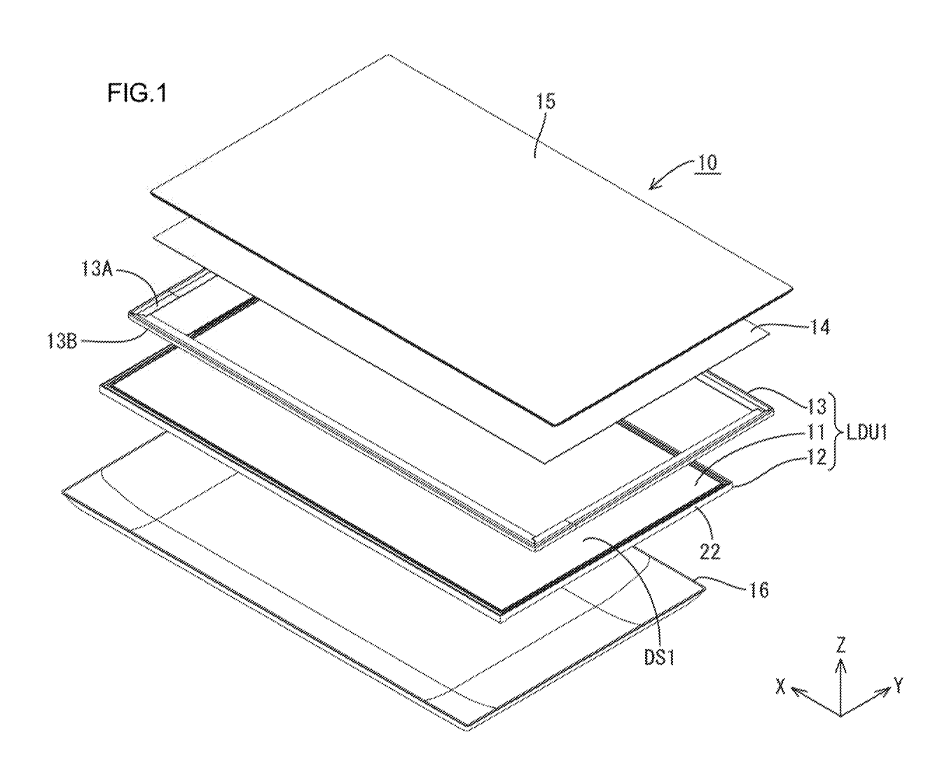

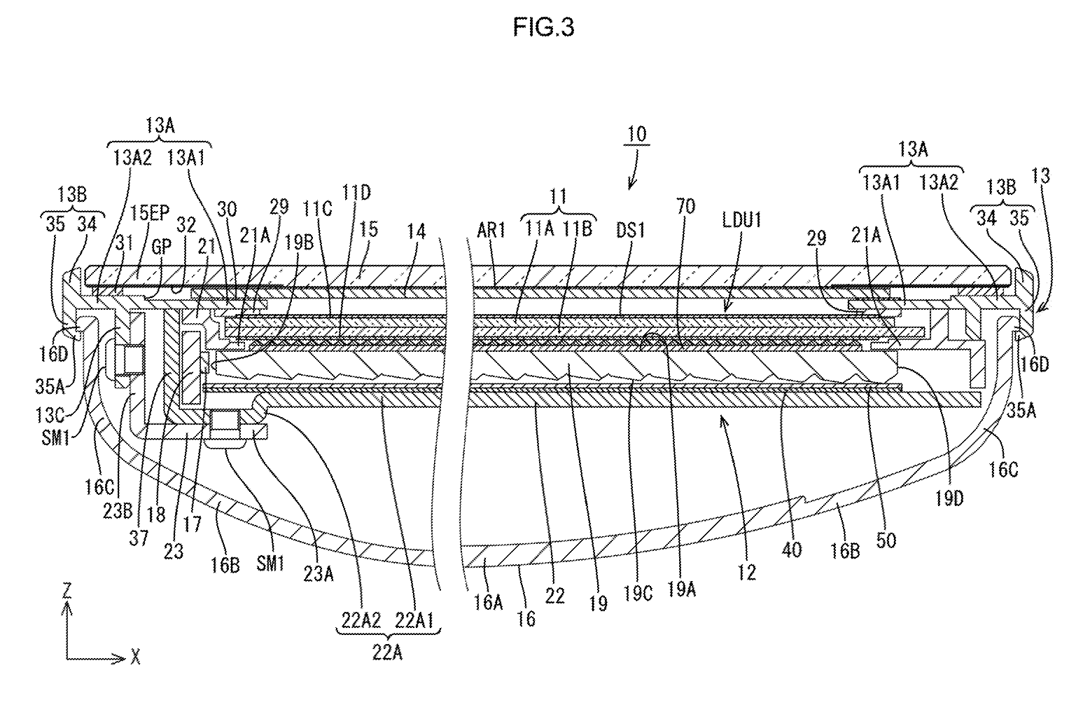

A first embodiment of the present invention will be described with reference to FIGS. 1 to 11. In the present embodiment, a liquid crystal display device 10 will be described as an example. X-axis, the Y-axis and the Z-axis may be present in the drawings and each of the axial directions represents a direction represented in each drawing. An up-down direction is referred to FIGS. 3 to 5 and an upper side and a lower side in the drawings correspond to a front side and a back side, respectively.

As illustrated in FIG. 1, the liquid crystal display device 10 has a rectangular plan-view shape as a whole, and includes a liquid display unit LDU1 that is a base component, and a touch panel 14, a cover panel 15 (a protection panel, a cover glass), and a casing 16 that are mounted in the liquid crystal display unit LDU1. The liquid crystal display unit LDU1 includes a liquid crystal panel 11 (a display panel), a backlight device 12 (a lighting device), and a frame 13 (casing member). The liquid crystal panel 11 has a display surface DS1 displaying images on a front side. The backlight device 12 is disposed on the back side of the liquid crystal panel 11 and light exits the backlight device 12 toward the liquid crystal panel 11. The frame 13 presses the liquid crystal panel 11 from the front side or an opposite side from the backlight device 12 with respect to the liquid crystal panel 11 (from a display surface DS1 side). The touch panel 14 and the cover panel 15 are arranged within the frame 13 of the liquid crystal display unit LDU1 from the front side and the frame 13 receives outer peripheral portions (including outer peripheral edge portions) of the panels from the back side.

The touch panel 14 is spaced from the liquid crystal panel 11 on the front side with a predetermined clearance and has a back side (inner side) plate surface that is an opposite surface that is opposite the display surface DS1. The cover panel 15 overlaps the touch panel 14 on the front side and has a back side (inner side) plate surface that is an opposite surface opposite the front side plate surface of the touch panel 14. An antireflection film AR1 is disposed between the touch panel 14 and the cover panel 15 (see FIG. 3). The casing 16 is mounted in the frame 13 to cover the liquid crystal display unit LDU1 from the back side. Among the components of the liquid crystal display devices 10, a part of the frame 13 (a loop portion 13B, which will be described later), the cover panel 15, and the casing 16 provide an outer appearance of the liquid crystal display device 10. The liquid crystal display device 10 of the present embodiment is used in electronic devices such as tablet computers and a screen size thereof is approximately 20 inches.

The liquid crystal panel 11 included in the liquid crystal display unit LDU1 will be described in detail. The liquid crystal panel 11 displays images with using light from the backlight device 12. As illustrated in FIGS. 1 and 3, the liquid crystal panel 11 includes a pair of substrates 11A, 11B and a liquid crystal layer (not illustrated) interposed between the substrates 11A, 11B. The substrates 11A, 11B have a plan view rectangular shape and are made of glass that is substantially transparent and has high transmissivity. The liquid crystal layer includes liquid crystal molecules having optical characteristics that change according to application of the electric field. The substrates 11A, 11B are adhered to each other via a sealing member (not illustrated) with having a gap of the liquid crystal layer therebetween. The liquid crystal panel includes a display area where images are displayed (a middle portion surrounded by a plate surface light blocking layer 32, which will described later) and a non-display area formed in a frame shape surrounding the display area and where no image is displayed (an outer peripheral portion overlapping the plate surface light blocking layer 32). A long-side direction of the liquid crystal panel 11 matches the X-axis direction (a first direction) and a short-side direction matches the Y-axis direction (a second direction), and a thickness direction matches the Z-axis direction.

Among the substrates 11A, 11B, a front-side (front-surface side) one is a color filter (CF) substrate 11A and a back-side (rear-surface side) one is an array substrate 11B. TFTs (thin film transistors), which are switching components, and pixel electrodes are disposed on an inner surface side (a liquid crystal layer side, on a side opposite the CF board 11A) with respect to the array board 11B. Gate lines and source lines are routed in a matrix near the TFTs and the pixel electrodes. The gate lines and the source lines receive certain image signals from a control circuit (not illustrated). The pixel electrode that is arranged in a square area defined by the gate lines and the source lines may be a transparent conductive film made of ITO (Indium Oxide Tin), and ZnO (Zinc oxide).

On the CF substrate 11A, color filters are arranged to overlap each of the pixel electrodes. The color filters includes red (R), green (G), and blue (B) color portions that are arranged alternately. A light blocking layer (a black matrix) is formed between the color portions to prevent mixing of the colors. Counter electrodes are arranged on surfaces of the color filter and the light blocking layer. The counter electrodes are opposite the pixel electrodes on the array substrate 11B side. The CF substrate 11A is slightly smaller than the array substrate 11B. Alignment films are disposed on the inner surface side of the substrates 11A, 11B to align the liquid crystal molecules included in the liquid crystal layer. Polarizing plates (not illustrated) are attached to the outer surfaces of the substrates 11A and 11B.

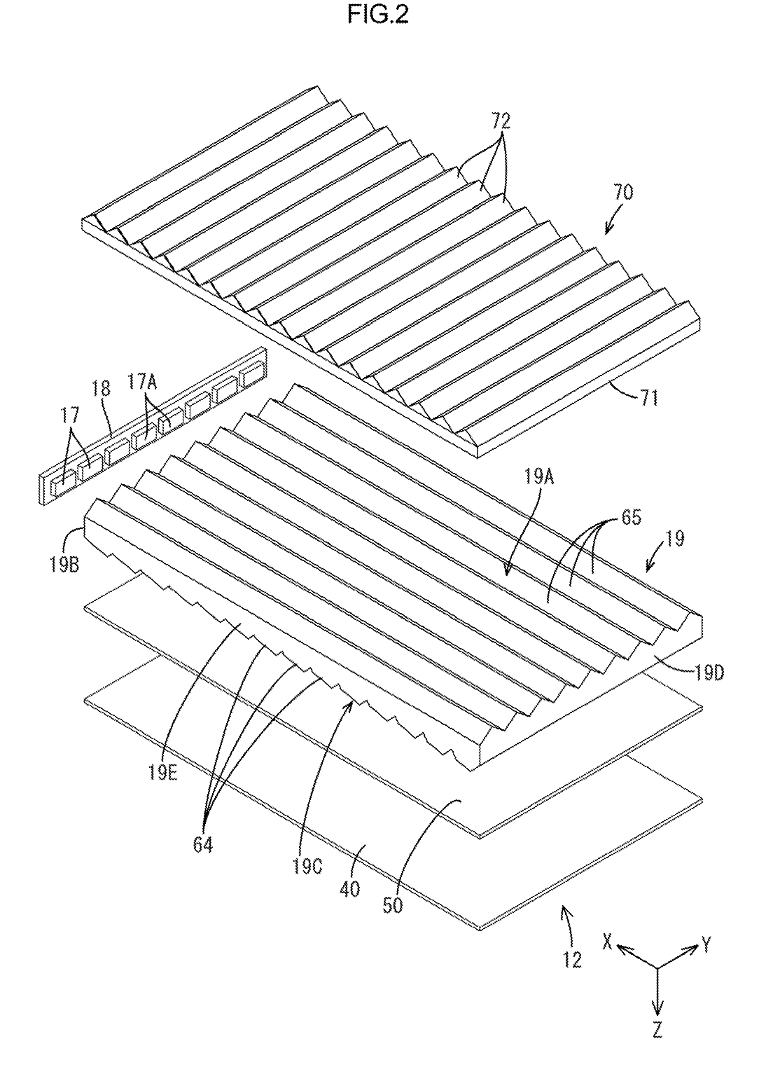

Next, the backlight device 12 of the liquid crystal display unit LDU1 will be described in detail. As illustrated in FIG. 1, the backlight device 12 has a plan-view rectangular block shape as a whole similar to that of the liquid crystal panel 11. As illustrated in FIGS. 2 and 3, the backlight device 12 includes LEDs 17 (light emitting diodes) that are light sources, an LED board 18 (a light source board) where the LEDs 17 are mounted, a light guide plate 19 that guides light from the LEDs 17, a light reflection sheet 40 (a light reflecting member) that reflects light from the light guide plate 19, a wavelength conversion sheet 50 (a wavelength conversion member) that is between the light guide plate 19 and the light reflection sheet 40, a prism sheet 70 (a light collection sheet) that is disposed to cover the light guide plate 19, a light blocking frame 21 that presses the light guide plate 19 from the front side, a chassis 22 where the LED board 18, the light guide plate 19, the prism sheet 70, and the light blocking frame 21 are arranged, and a heat dissipation member 23 that is arranged to be in contact with an outer surface of the chassis 22. The backlight device 12 includes the LEDs 17 (the LED board 18) on a short-side edge portion of an outer peripheral portion thereof and light enters through one side surface. The backlight device 12 is an edge-light type (a side-light type).

The LEDs 17 are mounted on a base board that is fixed on the LED board 18 and the LEDs 17 are configured by enclosing LED chips with resin material on the base board. The LED chips mounted on the base board emit light having one main light emission wavelength (approximately 420 nm to 500 nm) and specifically emit single blue light. The LEDs 17 are side-surface emitting type where side surfaces of the LEDs 17 are light emitting surfaces 17A. The side surfaces of the LEDs 17 are opposite surfaces from the mounting surfaces that are mounted on the LED board 18.

As illustrated in FIG. 2, the LED board 18 has an elongated plate shape that extends in the Y-axis direction (in the short side direction of the light guide plate 19 and the chassis 22). The LED board 18 is arranged in the chassis 22 such that a plate surface thereof is parallel to a Y-Z plane or is perpendicular to plate surfaces of the liquid crystal panel 11 and the light guide plate 19. Namely, the LED board 18 is arranged such that a long-side direction of the plate surface thereof matches the Y-axis direction and a short-side direction matches the Z-axis direction, and a thickness direction that is perpendicular to the plate surface thereof matches the X-axis direction. The LED board 18 is arranged such that an inner plate surface thereof is opposite a short-side edge surface of the light guide plate (a light entrance surface 19B, a light source opposing edge surface) with a predetermined clearance in the X-axis direction. Therefore, a direction in which the LEDs 17, the LED board 18, and the light guide plate 19 are arranged substantially matches the X-axis direction. The LED board 18 has a length dimension that is substantially same as or greater than the short-side dimension of the light guide plate 19 and is mounted on a short-side edge portion of the chassis 22, which will be described later.

The LEDs 17 are mounted on a mounting surface (an opposing surface opposite the light guide plate 19) of the LED board 18. An LED unit is configured by mounting the LEDs 17 on the LED board 18. The LEDs 17 are arranged along a line in a longitudinal direction (the Y-axis direction) of the LED board 18 at a predetermined interval. The LEDs 17 are arranged at an interval in the short-side direction on the short-side edge portion of the backlight device 12. The interval (an arrangement interval) between the adjacent LEDs 17 is substantially equal. The LED board 18 includes a tracing pattern (not illustrated) on the mounting surface thereof. The tracing pattern is made of a metal film (such as a copper foil) and extends in the Y-axis direction to cross the LEDs 17 and connect the adjacent LEDs 17 in series. The tracing pattern has end terminals that are connected to an external LED driving circuit so that driving power is supplied to the LEDs 17. A substrate of the LED board 18 is metal same as the chassis 22 and the tracing pattern (not illustrated) is formed on the surface of the substrate via an insulation layer. An insulation material such as ceramics may be used for the substrate of the LED board 18.

The light guide plate 19 is made of synthetic resin that has refractive index greater than air and high transmissivity and is substantially transparent (acrylic resin such as PMMA). As illustrated in FIGS. 2 and 3, the light guide plate 19 has a substantially rectangular plan-view plate shape similar to that of the liquid crystal panel 11. The light guide plate 19 has a plate surface that is parallel to the plate surface of the liquid crystal panel 11 (the display surface DS1). On the plate surface of the light guide plate 19, a long-side direction matches the X-axis direction, a short-side direction matches the Y-axis direction, and a plate thickness direction that is perpendicular to the plate surface matches the Z-axis direction. The light guide plate 19 that is made of acrylic resin such as PMMA has refractive index of approximately 1.49 and has a critical angle of approximately 42°. The material of the light guide plate 19 is not limited thereto.

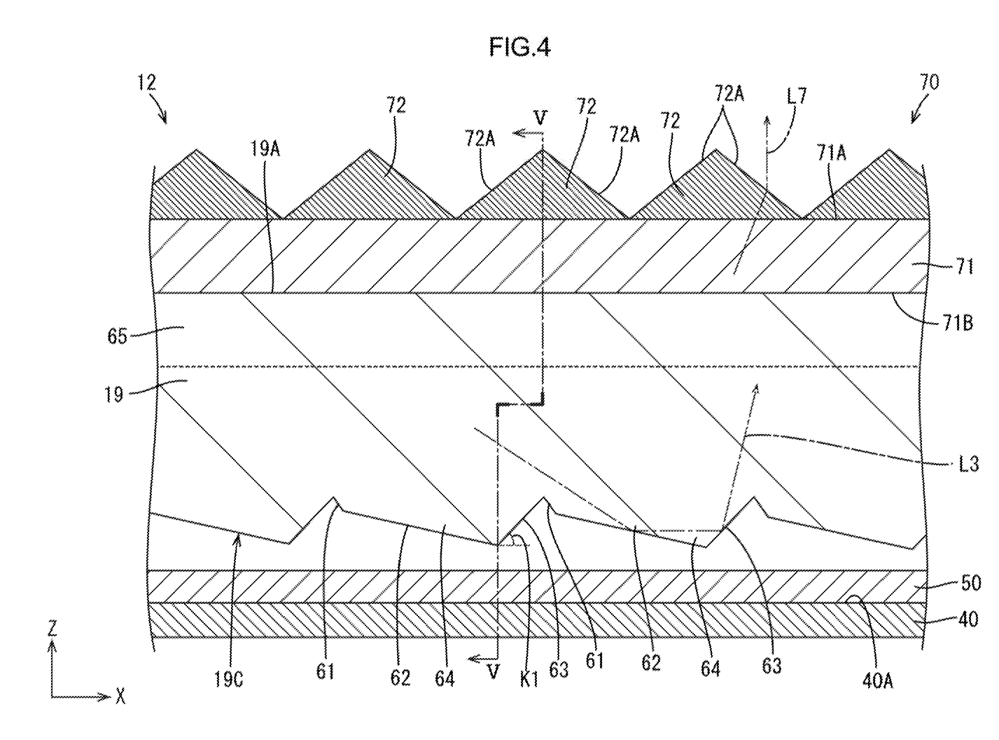

As illustrated in FIGS. 3 and 4, the light guide plate 19 is arranged directly below the liquid crystal panel 11 and the prism sheet 70 within the chassis 22. Among edge surfaces of the light guide plate 19, one short-side edge surface (the light entrance surface 19B) is opposite the LEDs 17 on the LED board 18 that is arranged in the short-side edge portion of the chassis 22. According to such a configuration, an arrangement direction in which the LEDs 17 (the LED board 18) and the light guide plate 19 are arranged matches the X-axis direction and an arrangement direction in which the prism sheet 70 (or the liquid crystal panel 11) and the light guide plate 19 are arranged (overlapped) matches the Z-axis direction, and the arrangement directions are perpendicular to each other.

The light entrance surface 19B of the light guide plate 19 extends in the Y-axis direction (one side direction of the light guide plate 19) and is perpendicular to the plate surface of the light guide plate (light exit surfaces 19A, 19C). The LEDs 17 are arranged in the longitudinal direction of the light entrance surface 19B. As illustrated in FIGS. 3 and 4, the light guide plate 19 has a front-side (light exit side) plate surface and a back-side plate surface that are light exit surfaces 19A, 19C through which light within the light guide plate 19 exit outward. Light exits the light guide plate 19 through the front-side light exit surface 19A toward the prism sheet 70 and the liquid crystal panel 11. Light exits the light guide plate 19 through the back-side light exit surface 19C toward a light reflection sheet 40, which will be described later. The light guide plate 19 has long-side edge surfaces that are side edge surfaces 19E, 19E. Light from the LEDs 17 enters the light guide plate 19 through the light entrance surface 19B and the light reflects off the light reflection sheet 40 or totally reflects off the light exit surfaces 19A, 19C and other outer peripheral edge surfaces (the edge surface 19D opposite from the light entrance surface 19B, and side edge surfaces 19E). Thus, the light effectively travels within the light guide plate 19.

As illustrated in FIG. 3, the light blocking frame 21 is formed in substantially a frame shape that extends along the outer peripheral portion (an outer peripheral edge portion) of the light guide plate 19. The light blocking frame 21 is configured to press substantially an entire outer peripheral portion of the light guide plate 19 from the front side. The light blocking frame 21 is made of synthetic resin and has a black surface to have a light blocking property. The light blocking frame 21 has an inner edge portion 21A that is disposed between the outer peripheral portion of the light guide plate 19 and the outer peripheral portion (outer peripheral edge portion) of the liquid crystal panel 11 and between the LEDs 17 and the outer peripheral portion (outer peripheral edge portion) of the prism sheet 70 over an entire periphery. According to such a configuration, a part of the rays of light emitted by the LEDs 17 and may not enter the light guide plate 19 through the light entrance surface 19B or leak from the light guide plate 19 through the outer peripheral edge surface thereof, and such light is less likely to directly enter the liquid crystal panel 11 and the prism sheet 70 through the outer peripheral portions thereof (especially edge surfaces).

The chassis 22 is made of a metal plate having good thermal conductivity such as aluminum plate or electro-galvanized steel plate (SECC). As illustrated in FIG. 3, the chassis 22 includes a bottom plate 22A that has a rectangular plan view shape similar to the liquid crystal panel 11, and side plates 37 each of which extends from an outer edge of each side (each of the long sides and each of the short sides) of the bottom plate 22A toward the front side. In the chassis 22 (or the bottom plate 22A), a long-side direction matches the X-axis direction and a short-side direction matches the Y-axis direction. Most part of the bottom plate 22A is a light guide plate support portion 22A1 that supports the light guide plate 19 from the back side and the bottom plate 22A has a base board arrangement portion 22A2 on the edge portion thereof near the LED board 18. The base board arrangement portion 22A2 projects toward the back side to form a step. A short-side side plate 37 that extends from the base board arrangement portion 22A2 is a base board mount portion where the LED board 18 is mounted. The LED board 18 is fixed on an inner plate surface of the side plate 37 via a base board fixing member such as a double-sided adhesive tape. A liquid panel drive circuit board (not illustrated) that controls driving of the liquid crystal panel 11, an LED drive circuit board (not illustrated) that supplies driving power to the LEDs 17, and a touch panel drive circuit board (not illustrated) that controls driving of the touch panel 14 are mounted on the rear plate surface of the bottom plate 22A of the chassis 22.

The heat dissipation member 23 is made of a metal plate having good thermal conductivity such as an aluminum plate. As illustrated in FIG. 3, the heat dissipation member 23 extends along a short-side edge portion of the chassis 22 or the base board arrangement portion 22A2 where the LED board 18 is arranged. The heat dissipation member 23 has a substantially L-shaped cross section and includes a first heat dissipation portion 23A that is in contact with an outer surface of the base board arrangement portion 22A2 and a second heat dissipation portion 23B that is parallel to an outer surface of the side plate 37. The first heat dissipation portion 23A is fixed to the base board arrangement portion 22A2 with screws SM1. Accordingly, heat generated by the LEDs 17 is transferred to the first heat dissipation portion 23A via the LED board 18, the side plate 37 (the base board mount portion), and the base board arrangement portion 22A2.

Next, the frame 13 included in the liquid crystal display unit LDU1 will be described. The frame 13 is made of metal material having good thermal conductivity such as aluminum. As illustrated in FIG. 1, the frame 13 is formed in a rectangular frame plan view shape as a whole and the frame 13 extends along each of the outer peripheral portions (the outer peripheral edge portions) of the liquid crystal panel 11, the touch panel 14, and the cover panel 15. The frame 13 may be manufactured with pressing. As illustrated in FIG. 3, the frame 13 presses the outer peripheral portion of the liquid crystal panel 11 from the front side and the frame 13 and the chassis 22 hold the liquid crystal panel 11, the prism sheet 70, and the light guide plate 19 therebetween. The frame 13 receives each of the outer peripheral portions of the touch panel 14 and the cover panel 15 from the rear side thereof and is disposed between the outer peripheral portions of the liquid crystal panel 11 and the touch panel 14. According to such a configuration, a certain clearance is provided between the liquid crystal panel 11 and the touch panel 14. Therefore, if an external force acts on the cover panel 15 and the touch panel 14 is deformed toward the liquid crystal panel 11 according to deformation of the cover panel 15, the deformed touch panel 14 is less likely to be in contact with the liquid crystal panel 11.

As illustrated in FIG. 3, the frame 13 includes a frame portion 13A, the loop portion 13B, and mount plate portion 13C. The frame portion 13A extends along each of the outer peripheral portions of the liquid crystal panel 11, the touch panel 14, and the cover panel 15. The loop portion 13B extends from the outer peripheral edge portion of the frame portion 13A and surrounds the touch panel 14, the cover panel 15, and the casing 16 from the outer peripheral side. The mount plate portion 13C projects from the frame portion 13A toward the back side and is mounted on the chassis 22 and the heat dissipation member 23. The frame portion 13A is formed in substantially a plate having a plate surface parallel to each of the plate surfaces of the liquid crystal panel 11, the touch panel 14, and the cover panel 15 and has a rectangular frame plan view shape. The frame portion 13A includes an inner peripheral portion 13A1 and an outer peripheral portion 13A2 that is relatively thicker than the inner peripheral portion 13A1. A level gap GP is provided at a border of the inner peripheral portion 13A1 and the outer peripheral portion 13A2. The inner peripheral portion 13A1 of the frame portion 13A is between the outer peripheral portion of the liquid crystal panel 11 and the outer peripheral portion of the touch panel 14 and the outer peripheral portion 13A2 receives the outer peripheral portion of the cover panel 15 from the back side thereof.

A substantially entire area of the front side plate surface of the frame portion 13A is covered with the cover panel 15, and the front side plate surface is less likely to be exposed to the outside. Therefore, even if a temperature of the frame 13 is increased due to heat from the LEDs 17, a user of the liquid crystal display device 10 is less likely to touch an exposed portion of the frame 13 and the device is good in safety. As illustrated in FIG. 3, a buffer member 29 is fixed on the back side plate surface of the inner peripheral portion 13A1 of the frame portion 13A to buffer the outer peripheral portion of the liquid crystal panel 11 and press the outer peripheral portion of the liquid crystal panel 11 from the front side. A first fixing member 30 is fixed on the front side plate surface of the inner peripheral portion 13A1 to buffer the outer peripheral portion of the touch panel 14 and fix it. The buffer member 29 and the first fixing member 30 are arranged to overlap each other with a plan view at the inner peripheral portion 13A1. A second fixing member 31 is fixed on the front side plate surface of the outer peripheral portion 13A2 of the frame portion 13A to buffer the outer peripheral portion of the cover panel 15 and fix it. Each of the buffer member 29 and the fixing members 30, 31 extends along each side portion of the frame portion 13A.

As illustrated in FIG. 3, the loop portion 13B has a rectangular short squarely cylindrical plan view shape as a whole, and includes a first loop portion 34 that extends from the outer peripheral edge of the outer peripheral portion 13A2 of the frame portion 13A toward the front side and a second loop portion 35 that extends from the outer peripheral edge of the outer peripheral portion 13A2 of the frame portion 13A toward the back side. The first loop portion 34 is arranged to surround entirely each of peripheral edge surfaces of the touch panel 14 and the cover panel 15 that are arranged on the front side with respect to the frame portion 13A. The first loop portion 34 has an inner peripheral surface that is opposite each of the outer peripheral edge surfaces of the touch panel 14 and the cover panel 15 and has an outer peripheral surface that is exposed to the outside of the liquid crystal display device 10 and provides an outer appearance of the side surface of the liquid crystal display device 10. The second loop portion 35 surrounds the front side edge portion (a mount portion 16C) of the casing 16, which is arranged on the back side with respect to the frame portion 13A, from the outer peripheral side. The second loop portion 35 has an inner peripheral surface that is opposite the mount portion 16C of the casing 16 (described later) and has an outer peripheral surface that is exposed to the outside of the liquid crystal display device 10 and provides the outer appearance of the side surface of the liquid crystal display device 10.

As illustrated in FIG. 3, the mount plate portion 13C projects from the outer peripheral portion 13A2 of the frame portion 13A toward the back side and is a plate extending along each of the sides of the frame portion 13A. The plate surface of the mount plate portion 13C is substantially perpendicular to the plate surface of the frame portion 13A. The mount plate portion 13C projects from each of the side portions of the frame portion 13A. The mount plate portion 13C projecting from the short-side portion of the frame portion 13A near the LED board 18 has an inner plate surface that is in contact with an outer plate surface of the second heat dissipation portion 23B of the heat dissipation member 23. The mount plate portion 13C is fixed on the second heat dissipation portion 23B with screws SM1. Accordingly, heat from the LEDs 17 is transferred from the first heat dissipation portion 23A to the second heat dissipation portion 23B and then transferred to the mount plate portion 13C and further to the whole frame 13. Thus, the heat dissipates effectively.

Next, the touch panel 14 will be described. As illustrated in FIGS. 1 and 3, the touch panel 14 is a position input device with which position information within a surface area of the display surface DS1 of the liquid crystal panel 11 is input by a user. The touch panel 14 includes a rectangular glass substrate that is substantially transparent and has good light transmissivity and a predetermined touch panel pattern (not illustrated) is formed on the glass substrate. Specifically, the touch panel 14 includes a glass substrate having a plan view rectangular shape similar to the liquid crystal panel 11 and a touch panel transparent electrode portion (not illustrated) on the front side plate surface thereof. The touch panel transparent electrode portion forms a projection-capacitive touch panel pattern and the touch panel transparent electrode portions are arranged in rows and columns within the plane surface of the substrate.

The short side edge portion of the touch panel 14 includes a terminal portion (not illustrated) that is connected to an end portion of a trace extending from the touch panel transparent electrode portion of the touch panel pattern. A flexible board (not illustrated) is connected to the terminal portion so that a potential is supplied from the touch panel drive circuit board to the touch panel transparent electrode portion that forms the touch panel pattern. As illustrated in FIG. 3, the inner plate surface of the outer peripheral portion of the touch panel 14 is fixed to the inner peripheral portion 13A1 of the frame portion 13A of the frame 13 via the first fixing member 30.

Next, the cover panel 15 will be described. As illustrated in FIGS. 1 and 3, the cover panel 15 is arranged to cover an entire area of the touch panel 14 from the front side and protect the touch panel 14 and the liquid crystal panel 11. The cover panel 15 covers an entire area of the frame portion 13A of the frame 13 from the front side and provides a front side outer appearance of the liquid crystal display device 10. The cover panel 15 has a rectangular plan view shape and is made of glass plate substrate that is substantially transparent and has good light transmissivity. The cover panel 15 is preferably made of toughened glass.

Chemically toughened glass including a chemically toughened layer on a surface thereof is preferably used as the toughened glass of the cover panel 15. The chemically toughened layer is provided by performing chemically toughening treatment on the surface of a glass plate substrate. The chemically toughening treatment is performed such that alkali metal ion contained in glass material is replaced with alkali metal ion having a greater ion radius with ion exchange treatment to strengthen the glass plate substrate. The obtained chemically toughened layer is a compressive stress layer (an ion exchange layer) where compressive stress remains. Therefore, the cover panel 15 has great mechanical strength and good shock resistance property, and the touch panel 14 and the liquid crystal panel 11 arranged on the back side of the cover panel 15 are not broken or damaged.

The cover panel 15 has a plan view size greater than that of the liquid crystal panel 11 and the touch panel 14. Therefore, the cover panel 15 has an extended portion 15EP extending outward further from each of the outer peripheral edges of the liquid crystal panel 11 and the touch panel 14 over an entire periphery. The extended portion 15EP has a rectangular frame shape surrounding the liquid crystal panel 11 and the touch panel 14. As illustrated in FIG. 3, the extended portion 15EP has an inner plate surface that is fixed to and opposite the outer peripheral portion 13A2 of the frame portion 13A of the frame 13 via the second fixing member 31. A middle portion of the cover panel 15 is opposite the touch panel 14 and is layered on the front side of the touch panel 14 via the antireflection film AR1.

As illustrated in FIG. 3, the plate surface light blocking layer 32 (a light blocking layer, a plate surface light blocking portion) is formed on the outer peripheral portion of the cover panel 15 including the extended portion 15EP on the back side plate surface thereof (a plate surface facing the touch panel 14). The plate surface light blocking layer 32 is made of light blocking material such as black coating material and such light blocking material is printed on the inner plate surface of the cover panel 15. Thus, the plate surface light blocking layer 32 is integrally formed on the plate surface of the cover panel 15. The plate surface light blocking layer 32 may be printed with printing methods such as screen printing or ink jet printing. The plate surface light blocking layer 32 is formed on an entire area of the extended portion 15EP of the cover panel 15 and a portion of the cover panel 15 that is inside the extended portion 15EP and overlaps each of the outer peripheral portions of the touch panel 14 and the liquid crystal panel 11 in a plan view. Accordingly, the plate surface light blocking layer 32 is arranged to surround the display area of the liquid crystal panel 11 and blocks light outside the display area. Therefore, display quality of images displayed in the display area is improved.

Next, the casing 16 will be described. The casing 16 is made of synthetic resin or metal material, and as illustrated in FIGS. 1 and 3, the casing 16 has substantially a bowl shape that is open toward the front side. The casing 16 covers the frame portion 13A and the mount plate portion 13C of the frame 13, the chassis 22, and the heat dissipation member 23 from the back side and provides the back side outer appearance of the liquid crystal display device 10. As illustrated in FIG. 3, the casing 16 includes substantially a flat bottom portion 16A, curved portions 16B, and mount portions 16C. The curved portions 16B extend from the respective outer peripheral edges of the bottom portion 16A toward the front side and have a curved cross sectional shape. The mount portions 16C extend substantially vertically from the respective outer peripheral edges of the curved portions 16B toward the front side. Each of the mount portions 16C has a casing side stopper portion 16D having a hooked cross sectional shape. The casing side stopper portion 16D is stopped by a frame side stopper portion 35A of the frame 13 such that the casing 16 is mounted in the frame 13.

A configuration of the light guide plate 19 will be described in detail. As illustrated in FIG. 4, the light exit surface 19C (a light exit surface covered with a light reflecting member) of the light guide plate 19 includes three inclined surfaces (a first inclined surface 61, a second inclined surface 62, a third inclined surface 63) having different inclination angles. A first prism portion 64 is configured by the three inclined surfaces 61, 62, 63. The inclined surfaces 61, 62, 63 extend in the Y-axis direction. The first prism portion 64 has a ridgeline extending in the Y-axis direction (the arrangement direction of the LEDs 17). The first prism portions 64 are arranged in the X-axis direction.

The first inclined surface 61 is inclined to be closer to the light reflection sheet 40 (a lower side in FIG. 4) as is farther away from the LEDs 17 (the light entrance surface 19B) in the X-axis direction. The second inclined surface 62 is inclined to be closer to the light reflection sheet 40 (the lower side in FIG. 4) as is farther away from the LEDs 17 (the light entrance surface 19B) in the X-axis direction. The second inclined surface 62 is continuous from one end of the first inclined surface 61 (an end portion farther from the LEDs 17) and the second inclined surface 62 has an inclination angle with respect to the X-axis that is smaller than an inclination angle of the first inclined surface 61. The third inclined surface 63 is inclined to be closer to the light exit surface 19A (an upper side in FIG. 4) as is farther away from the LEDs 17 (the light entrance surface 19B) in the X-axis direction. The third inclined surface 63 is continuous from one end of the second inclined surface 62 (an end portion farther from the LEDs 17).

Among the rays of light travelling within the light guide plate 19 and reaching the third inclined surface 63 from the LED 17 side (the left side in FIG. 4), light entering through the third inclined surface 63 at an incident angle not less than a critical angle is reflected by the third inclined surface 63 in a direction toward the light exit surface 19A (as is represented by an arrow L3 in FIG. 4). The third inclined surface 63 (an inclined surface inclined toward the light exit surface and not being covered with the light reflecting member) is a light collection portion that collects light to travel in the Z-axis direction (in a normal direction of the plate surface (the light exit surface 19A, 19C) of the light guide plate 19, in the plate thickness direction of the light guide plate 19). Accordingly, light reflecting off the third inclined surface 63 is incident on the light exit surface 19A at an angle of incident not greater than the critical angle (the light is not totally reflected by the light exit surface 19A). Thus, the light exits the fight guide plate through the light exit surface 19A.

The third inclined surfaces 63 are provided in the X-axis direction (in a direction farther from the light source) and have an area that increases as is farther away from the LEDs 17. Accordingly, the amount of light exiting through the light exit surface 19A is even within a surface area of the light exit surface 19A. Further, as illustrated by the arrow L3 in FIG. 4, the light reflects off the second inclined surface 62 so that the light is likely to reach the third inclined surface 63 and a greater amount of light reflects off the second inclined surface 62 in a direction toward the light exit surface 19A. By providing the first inclined surface 61, the third inclined surface 63 has one end that is closer to the light exit surface 19A compared to a configuration without having the first inclined surface 61. Accordingly, the third inclined surface 63 has greater area.

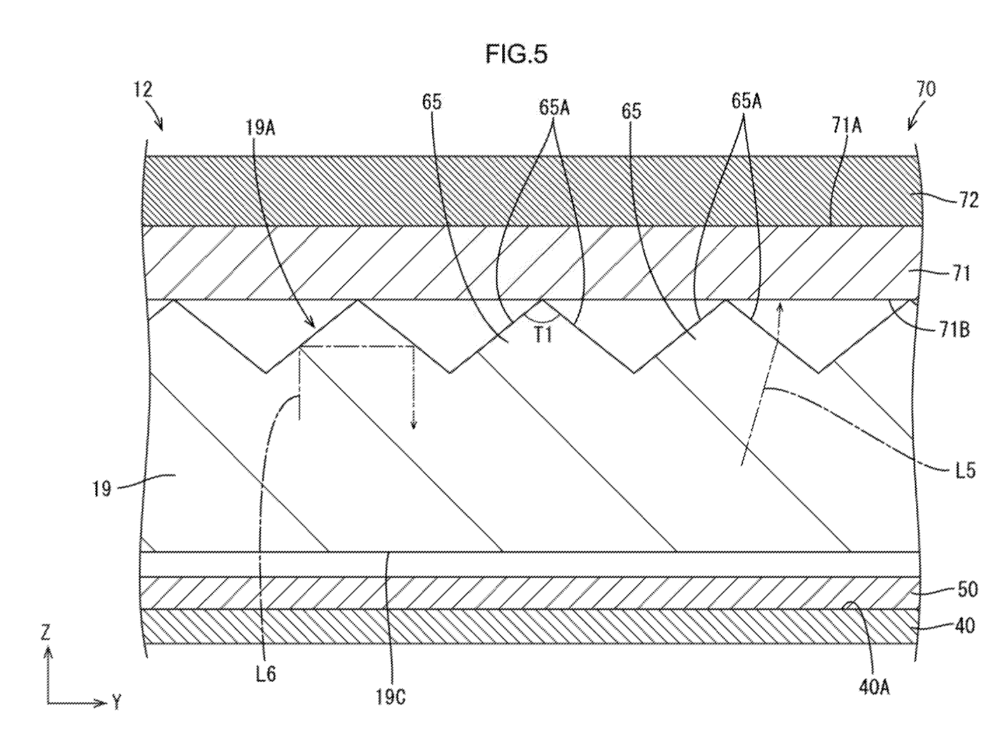

As illustrated in FIG. 5, the light guide plate 19 includes second prism portions 65 on the light exit surface 19A. To form the second prism portions 65 on the light guide plate 19, the light guide plate 19 may be manufactured with injection molding with using a molding die having a molding shape of the second prism portions 65 on a molding surface thereof for forming the second prism portions 65. As illustrated in FIG. 2, the second prism portions 65 are arranged in the Y-axis direction and each of them extends in the X-axis direction. As illustrated in FIG. 5, the second prism portions 65 have a triangular cross-sectional shape projecting toward the front side (toward the light exit side of the backlight device 12) and each of them includes a pair of inclined surfaces 65A, 65A.

The second prism portions 65 apply anisotropic light collecting action to the light that travels within the light guide plate 19 and reaches the light exit surface 19A, and the anisotropic light collecting action is described as follows. If the light reaching the light exit surface 19A is incident on the inclined surface 65A of the second prism portion 65 at an angle of incident not greater than the critical angle, the light is refracted by the inclined surface 65A and exits the light guide plate 19 (as illustrated by an arrow L5 in FIG. 5). As a result, the light is collected by the second prism portions 65 with respect to the Y-axis direction (the arrangement direction of the light sources). Namely, the second prism portions 65 (a unit light collecting portion) form the light collecting portion. A part of the rays of light reaching the light exit surface 19A is incident on the inclined surface 65A at an angle of incident greater than the critical angle and such light is totally reflected by the inclined surface 65A toward the light exit surface 19C (retroreflection). Such light is illustrated by an arrow L6 in FIG. 5.

A part of the rays of light travelling within the light guide plate 19 and reaching the light exit surface 19C is incident on the light exit surface 19C at an angle not greater than the critical angle. Such light exits through the light exit surface 19C and travels toward the light reflection sheet 40 (and the wavelength conversion sheet 50). In the present embodiment, the light exiting through the light exit surface 19C passes through the wavelength conversion sheet 50 and is reflected by the light reflection sheet 40 toward the light guide plate 19. The light reflection sheet 40 is made of synthetic resin and has a white surface (a light reflection surface 40A) having good light reflectivity. The material and the color of the light reflection sheet 40 are not limited thereto. The light reflection sheet 40 is mounted on the bottom plate 22A of the chassis 22 and covers an entire area of the light exit surface 19C. As illustrated in FIG. 3, the edge portion of the light reflection sheet 40 close to the LEDs 17 is located closer to the LEDs 17 than the light entrance surface 19B. Accordingly, the light from the LEDs 17 is reflected by the edge portion of the light reflection sheet 40 and the light entrance efficiency of light that is incident on the light entrance surface 19B is improved.

The wavelength conversion sheet 50 includes a phosphor layer that emits red light and a phosphor layer that emits green light (a wavelength conversion layer). The phosphor layers are excited by light of single color of blue that is emitted by the LEDs 17 and emit light in a red wavelength range of visible light and emit light in a green wavelength range of visible light. The wavelength conversion sheet 50 converts wavelength of the light of single color of blue that is emitted by the LEDs 17 into red light and green light that are different from the single color of blue. Specifically, each of the phosphor layers of the wavelength conversion sheet 50 is excited by blue light. The green phosphor layer (a green wavelength conversion portion) contains green phosphor that is excited by blue light and emits green light having an emission wavelength in a green wavelength range (approximately 500 nm to 570 nm). The red phosphor layer (a red wavelength conversion portion) contains a red phosphor that is excited by blue light and emits red light having an emission wavelength in a red wavelength range (approximately 600 nm to 780 nm).

The phosphor contained in each phosphor layer is a phosphor of a down conversion type (down shifting type) that has excitation wavelength shorter than the fluorescent wavelength. Such a phosphor of the down conversion type converts excitation light having relatively short wavelength and great energy into fluorescent light having relatively long wavelength and small energy. Therefore, in the present embodiment, the quantum efficiency (conversion efficiency of light) is 30% to 50% and is improved compared to a configuration where the phosphor of an up conversion type having the excitation wavelength longer than the fluorescent wavelength is used (quantum efficiency is approximately 28%).

A quantum dot phosphor may be used as the phosphor contained in each of the phosphor layers. Electrons, electron holes, and exciton are closed in a semiconductor crystal of nanometers in size (for example, diameter of approximately 2 nm to 10 nm) within a whole three-dimensional space and thus, the quantum dot phosphor obtains a discrete energy level. A peak wavelength of emitted light (color of emitted light) is effectively selected by changing the dots' size. Fluorescence of each phosphor layer containing such a quantum dot phosphor has a light emission spectrum having a steep peak and a small half-value width. Therefore, purity of color is quite high and color gamut is wide.

A material of the quantum dot phosphor includes a material (such as CdSe (cadmium selenide) and ZnS (zinc sulfide)) obtained by combining Zn, Cd, Hg, or Fb that will be a bivalent cation and O, S, Se, or Te that will be a bivalent anion, a material (such as InP (indium phosphide) and GaAs (gallium arsenide)) obtained by combining Ga or In that will be a trivalent cation and P, As, or Sb that will be a trivalent anion, and chalcopyrite type compound (such as CuInSe2). In the present embodiment, among the above materials, CdSe and ZnS are used as the material of the quantum dot phosphor. The quantum dot phosphor used in the present embodiment is a core/shell quantum dot phosphor. The core/shell quantum dot phosphor includes a quantum dot that is covered with a semiconductor material having relatively great band gap. Specifically, “Lumidot (registered trademark) CdSe/ZnS” made by SIGMA-ALDRIH JAPAN is preferably used as the core/shell quantum dot phosphor.

As illustrated in FIG. 4, the prism sheet 70 is disposed to cover the light exit surface 19A of the light guide plate 19 (one of the light exit surfaces that is not covered with the light reflecting member). The prism sheet 70 includes a base sheet 71 and prism portions (unit light collecting portions) 72. The prism portions 72 are formed on the light exit-side plate surface 71A of the base sheet 71. The light exit-side plate surface 71A is opposite from (on a light exit side) a light entrance-side plate surface 71B through which light from the light guide plate 19 enters the base sheet 71. The base sheet 71 is made of substantially transparent synthetic resin and specifically made of thermoplastic resin material such as PET and refractive index of the material is approximately 1.667. The prism portions 72 are integrally formed with the light exit-side plate surface 71A of the base sheet 71.

The prism portions 72 are made of substantially transparent ultraviolet-curing resin material that is a kind of photo-curable resin. In manufacturing the prism sheet 70, a molding die is filled with uncured ultraviolet-curing resin material and the base sheet 71 is put on an opening edge of the molding die such that the uncured ultraviolet-curing resin material is in contact with the light exit-side plate surface 71A. Then, the ultraviolet-curing resin material is irradiated with ultraviolet rays via the base sheet 71 so as to be cured and the prism portions 72 are integrally formed with the base sheet 71. The ultraviolet-curing resin material of the prism portions 72 is acrylic resin such as PMMA, for example, and refractive index thereof is approximately 1.59.

The prism portions 72 project from the light exit-side plate surface 71A of the base sheet 71 toward the front side (the light exit side). Each of the prism portions 72 has substantially a triangular cross-sectional shape (a mountain shape) taken in the X-axis direction and extends linearly in the Y-axis direction. The prism portions 72 are arranged in the X-axis direction. Each of the prism portions 72 has a width dimension (in the X-axis direction) that is constant over an entire length thereof. Each of the prism portions 72 has substantially an isosceles triangular cross-sectional shape and includes a pair of inclined surfaces 72A.

Light enters the prism sheet 70 having the above configuration through a surface near the light guide plate 19. The light enters the base sheet 71 through the light entrance-side plate surface 71B via an air layer between the light exit surface 19A of the light guide plate 19 and the base sheet 71 of the prism sheet 70. Therefore, the light is refracted at a border surface between the air layer and the light entrance-side plate surface 71B according to the angle of incident. When the light passing through the base sheet 71 exits the base sheet 71 through the light exit-side plate surface 71A and enters the prism portions 72, the light is refracted at a border surface according to the angle of incident. The light travelling through the prism portions 72 reaches the sloped surfaces 72A of the prism portions 72. If the angle of incident on the sloped surface 72A is greater than the critical angle, the light is totally reflected by the sloped surface 72A and returned into the base sheet 71 (retroreflection). If the angle of incident on the sloped surface 72A is not greater than the critical angle, the light is refracted by the border surface and exits the prism portion 72 (illustrated by an arrow L7 in FIG. 4).

According to the above configuration, the light exiting the prism portions 72 are collected to travel in a front direction (normal direction of the light exit surface 19A) with respect to the X-axis direction. Namely, the prism portions 72 have anisotropic light collecting properties. A part of the rays of light exiting the prism portions 72 through the inclined surface 72A may travel toward the adjacent prism portion 72 and enter the adjacent prism portion 72 and return toward the base sheet 71. As described before, the second prism portions 65 of the light guide plate 19 are configured to collect light with respect to the Y-axis direction. The prism sheet 70 is configured to collect light with respect to a direction along a plate surface of the light guide plate 19 and a direction perpendicular to a light collection direction in which light is collected by the second prism portions 65.

Next, operations and effects of the present embodiment will be described. In the present embodiment, light from each LED 17 enters the light guide plate 19 through the light entrance surface 19B and travels within the light guide plate 19 and exits the light guide plate 19 through the light exit surfaces 19A, 19C. The light exiting the light guide plate 19 through the light exit surface 19C (a first light exit surface) near the light reflection sheet 40 passes through the wavelength conversion sheet 50 and reflects off the light reflection sheet 40 toward the light guide plate 19. Then, the light passes through the wavelength conversion sheet 50 again and enters the light guide plate 19 through the light exit surface 19C and exits the light guide plate 19 through the light exit surface 19A (a second light exit surface).

Accordingly, the light exiting the light guide plate 19 through the light exit surface 19A includes light that is emitted by the LEDs 17 and travels toward the light exit surface 19A without passing through the wavelength conversion sheet 50 (light having wavelength same as that of the light emitted by the LEDs 17) and light that is emitted by the LEDs 17 and travels toward the light exit surface 19A after passing through the wavelength conversion sheet 50. In the present embodiment, the LEDs 17 emit blue light and the wavelength conversion sheet 50 is excited by the blue light and exits green light and red light. Therefore, light (white light) obtained by mixing blue light, green light, and red light exits through the light exit surface 19A.

In the present embodiment, the light guide plate 19 includes the second prism portions 65 on the light exit surface 19A. Therefore, the light passing through the wavelength conversion sheet 50 is collected by the second prism portions 65 and exits the light guide plate 19 through the light exit surface 19A. If the wavelength conversion sheet is arranged to cover the light exit surface 19A of the light guide plate 19, the wavelength conversion sheet is required to be covered with a light collection sheet to collect light passing through the wavelength conversion sheet. In the present embodiment, the wavelength conversion sheet 50 is between the light guide plate 19 and the light reflection sheet 40 and the light guide plate 19 includes the second prism portions 65. According to such a configuration, the light passing through the wavelength conversion sheet and travels toward the light guide plate 10 can be collected. As a result, the number of the light collection sheets (a light collection sheet having same light collecting action as that of the second prism portions 65) is reduced with maintaining good front luminance (luminance seen from the normal direction of the light exit surface 19A (the Z-axis direction)).

The light guide plate 19 has a rectangular shape and the light entrance surface 19B has an elongated shape extending in one side direction of the light guide plate 19 (in the Y-axis direction). The LEDs 17 are arranged in the longitudinal direction of the light entrance surface 19B and the second prism portions 65 are configured to collect light with respect to the arrangement direction in which the LEDs 17 are arranged. According to such a configuration, the light can be effectively collected with respect to the arrangement direction in which the LEDs 17 are arranged. The second prism portions 65 extending in the other side direction of the light guide plate 19 (in the X-axis direction) are arranged in the Y-axis direction. Accordingly, the second prism portions 65 provide light collecting action.

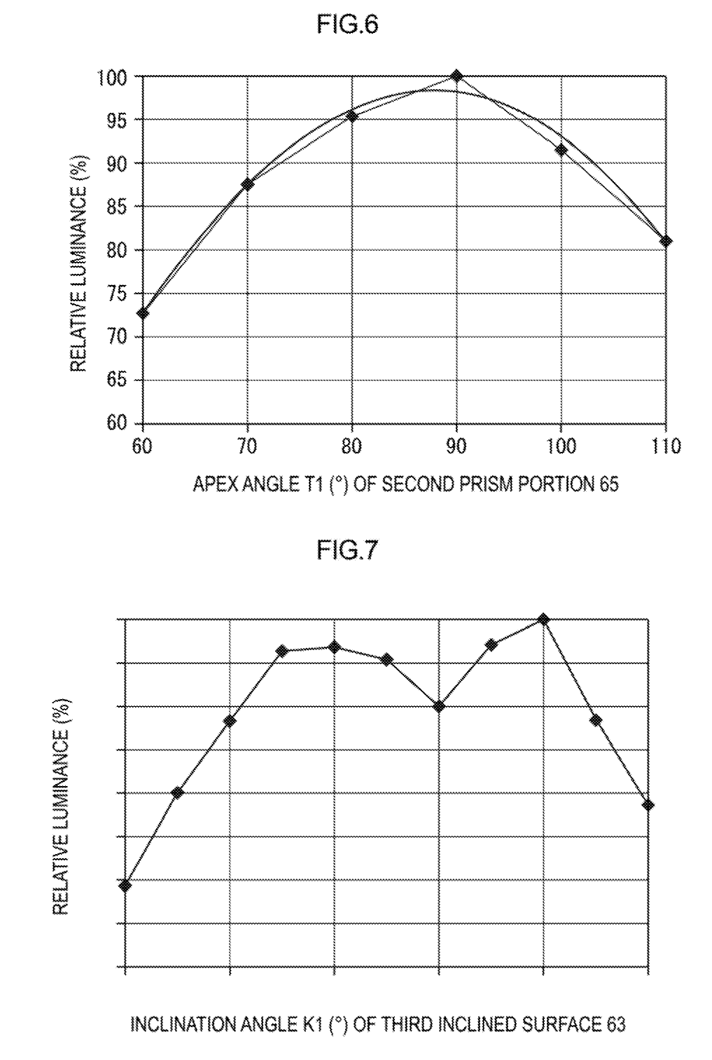

The apex angle T1 of each second prism portion 65 (an angle formed by the pair of sloped surfaces 65A, 65A) can be appropriately determined. FIG. 6 is a graph illustrating correlation of the apex angle T1 and front luminance of exit light exiting through a light exit surface 19A. The relative luminance illustrated in FIG. 6 is a relative value obtained based on a reference that a luminance value of the exit light exiting through the light exit surface 19A with the apex angle T1 of 90° is 100%. In FIG. 6, the luminance is maximum when the apex angle T1 is 90° and the luminance increases as the apex angle T1 is closer to 90°. Especially, when the apex angle T1 is within a range of 70° to 100°, the luminance is maintained at 85% or more of the maximum value. Therefore, the apex angle T1 is preferably within the range of 70° to 100°.

The light exit surface 19C of the light guide plate 19 includes the third inclined surfaces 63 each of which is inclined toward the light exit surface as is farther away from the LEDs 17. The third inclined surfaces 63 are arranged in the direction farther away from the LEDs 17 (in the X-axis direction).

According to such a configuration, a part of the rays of light travelling within the light guide plate 19 is reflected by the third inclined surfaces 63 toward the light exit surface 19A. As a result, the amount of light travelling in the normal direction of the light exit surface 19A (in the Z-axis direction) is increased and the front luminance is increased. An inclination angle K1 of the third inclined surface 63 (an angle between the third inclined surface 63 and plate surface of the light guide plate) may be preferably determined. FIG. 7 is a graph illustrating correlation of the inclination angle K1 and front luminance of exit light exiting through the light exit surface 19A. The relative luminance illustrated in FIG. 7 is a relative value obtained based on a reference that a luminance value of the exit light exiting through the light exit surface 19A with the inclination angle K1 of 60° is 100%. In FIG. 7, the luminance is maximum when the inclination angle K1 is 60° and when the inclination angle K1 is within a range of 35° to 60°, the luminance is maintained at 95% or more of the maximum value. Therefore, the inclination angle K1 is preferably within the range of 35° to 60°.

The third inclined surfaces 63 have an area that is increased as is farther away from the LEDs 17. According to such a configuration, a greater amount of light is reflected by the third inclined surface 63 that is farther from the LEDs 17 in a direction toward the light exit surface 19A. Generally, the amount of exit light is reduced as a position of the light guide plate 19 is farther away from the LEDs 17. According to the configuration where each area of the third inclined surfaces 63 is set as described above, luminance unevenness is less likely to occur in the light exiting through the portion of the light exit surface 19A closer to the LEDs 17 and the portion thereof farther away from the LEDs 17 (luminance unevenness is less likely to occur in the X-axis direction).

The prism sheet 70 is disposed to cover the light exit surface 19A and collect the light in a direction toward the normal line of the light exit surface 19A. According to such a configuration, the light collected by the second prism portions 65 of the light guide plate 19 is further collected by the prism sheet 70. Accordingly, the front luminance of the exit light of the backlight device 12 is further increased.

In the present embodiment, the prism sheet 70 is configured to collect light with respect to the direction along the plate surface of the light guide plate 19 and the direction perpendicular to the light collection direction by the second prism portions 65 (the X-axis direction). According to such a configuration, the light collected by the second prism portions 65 with respect to the Y-axis direction is collected by the prism sheet 70 with respect to the X-axis direction. Accordingly, the light is collected in the plate surface direction of the light guide plate 10 (in the X-axis direction and in the Y-axis direction) and the front luminance of the exit light of the backlight device 12 is further increased.

The liquid crystal display device 10 of the present embodiment includes the backlight device 12 and the liquid crystal panel 11 that displays images with using light from the backlight device 12. According to the liquid crystal display device 10 having such a configuration, the front luminance of exit light from the backlight device 12 is increased and display quality is improved.

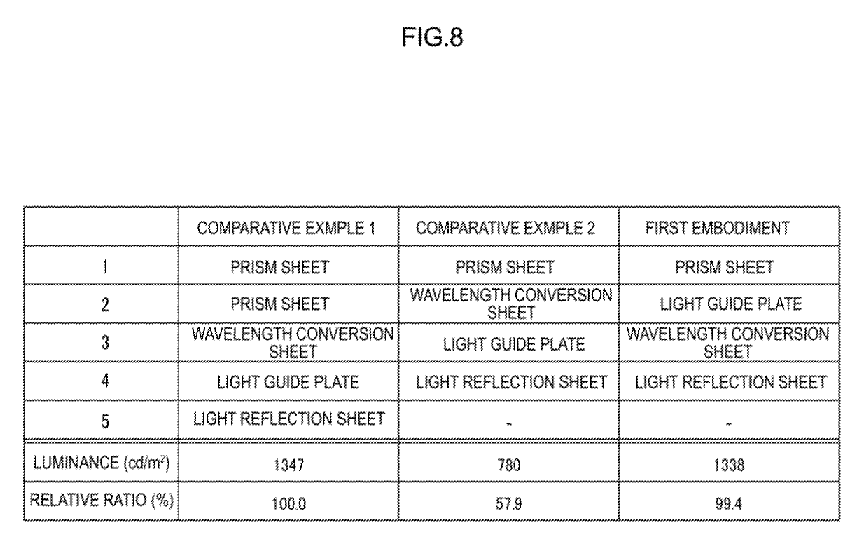

Next, effects of the present embodiment will be described with comparing to Comparative Examples 1 and 2. FIG. 8 illustrates a table describing configurations of the present embodiment, Comparative Examples 1 and 2 in the backlight device. In Comparative Example 1, the wavelength conversion sheet is provided to cover the light exit surface of the light guide plate on the opposite side from the light reflection sheet (on the light exit surface side of the backlight device) and two prism sheets are provided to cover the wavelength conversion sheet (one of the prism sheets is for collecting light with respect to the X-axis direction and the other one is for collecting light with respect to the Y-axis direction). In Comparative Example 2, the wavelength conversion sheet is provided to cover the light exit surface of the light guide plate on the opposite side from the light reflection sheet (on the light exit surface side of the backlight device) and one prism sheet is provided to cover the wavelength conversion sheet (that is for collecting light with respect to the X-axis direction).

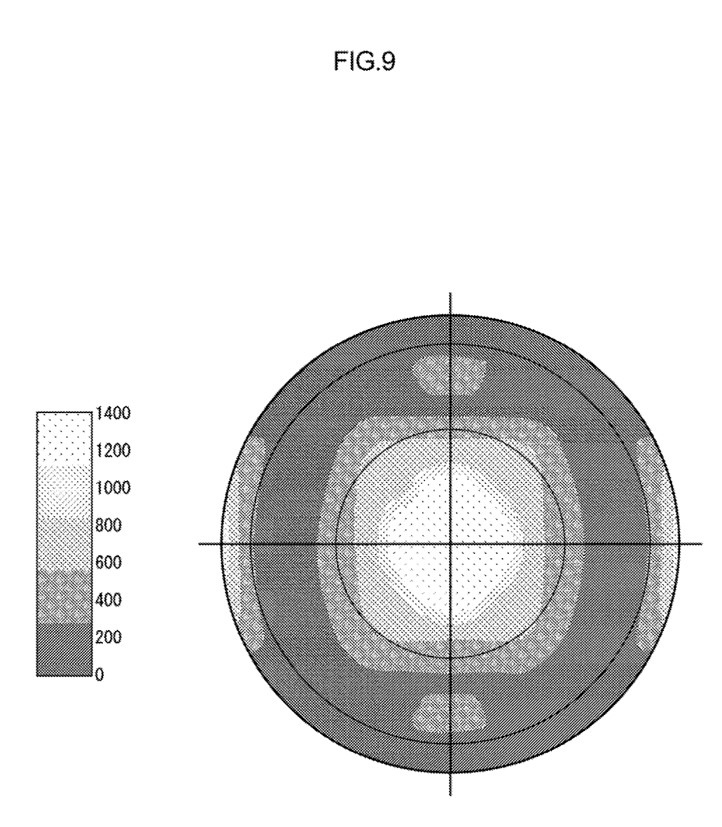

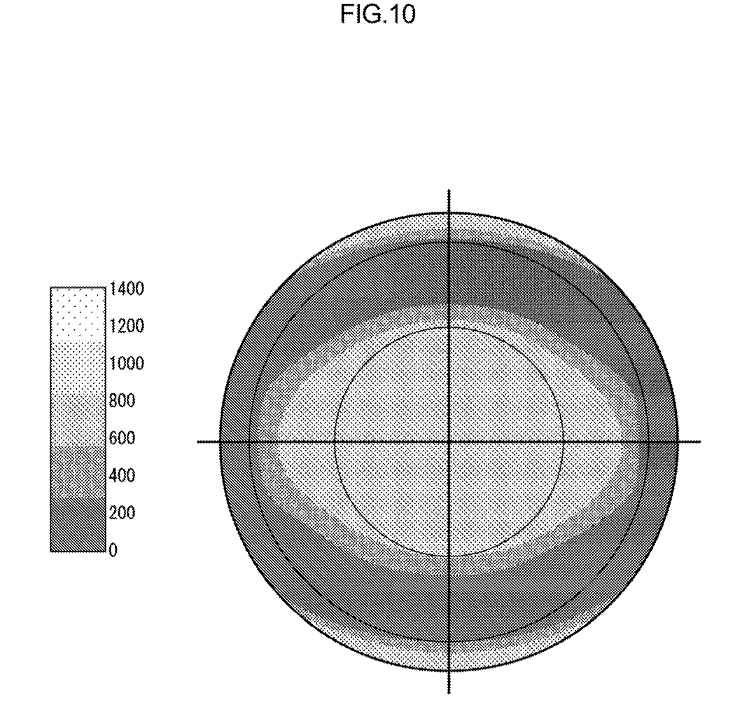

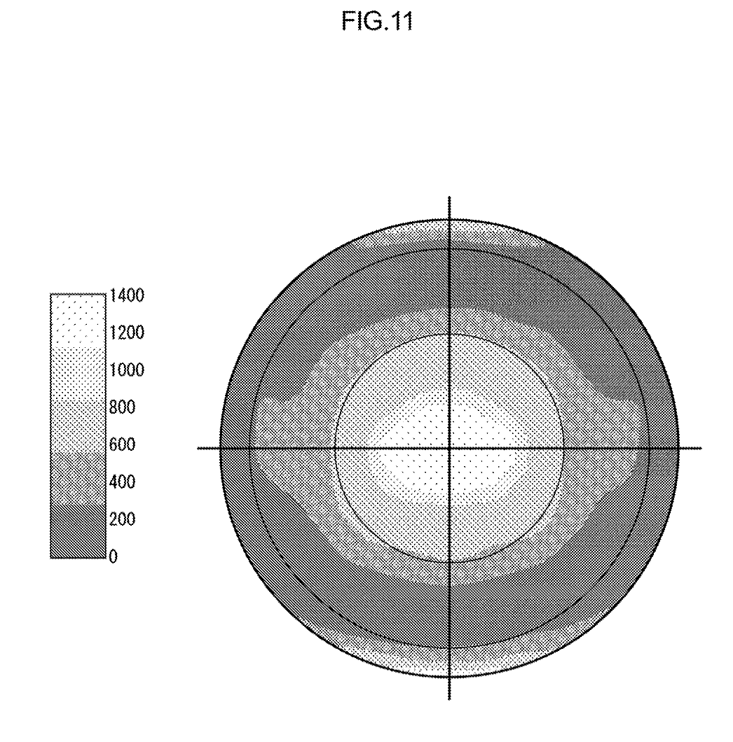

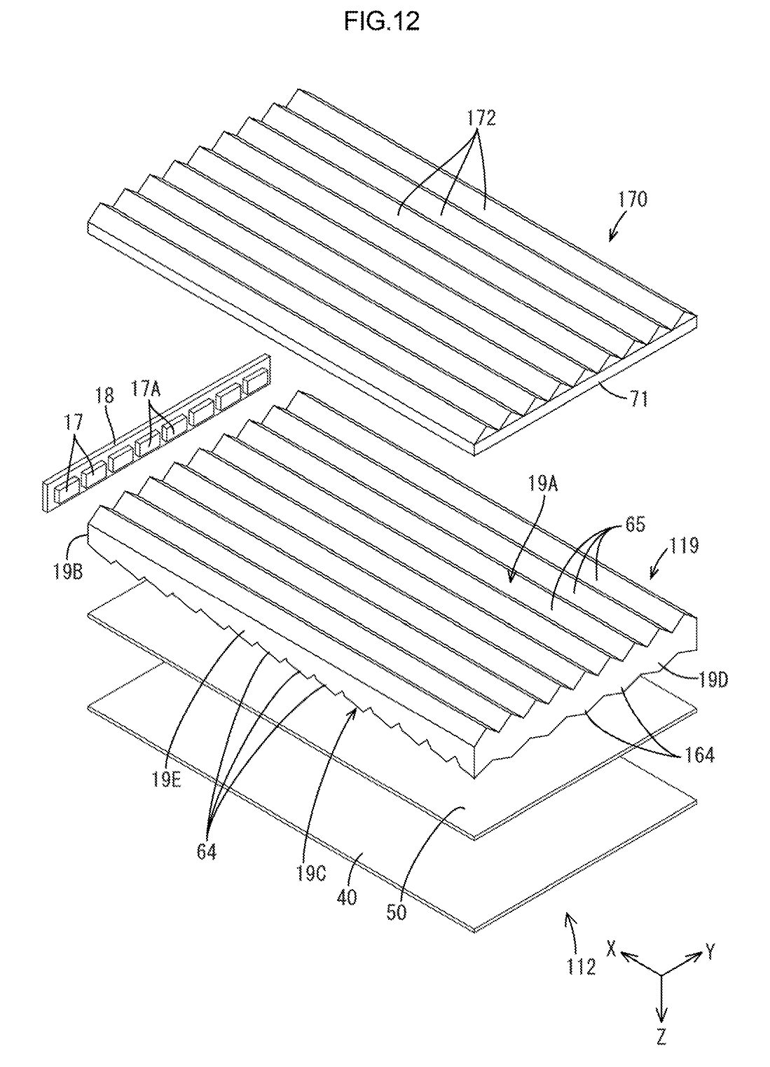

Measurement results of luminance of exit light from the backlight device of each of Comparative Examples 1 and 2, and the present embodiment are illustrated in FIGS. 9 to 11. FIGS. 9 to 11 illustrate a luminance angle distribution of exit light with reference to a front direction (the Z-axis direction, with the backlight device seen from the front side). FIG. 9 illustrates a luminance angle distribution of Comparative Example 1, and FIG. 10 illustrates a luminance angle distribution of Comparative Example 1. FIG. 11 illustrates a luminance angle distribution of the first embodiment. In FIGS. 9 to 11, a horizontal axis represents an angle of light travelling in the Y-axis direction with reference to the front direction and a vertical axis represents an angle of light travelling in the X-axis direction with reference to the front direction. In FIGS. 9 to 11, a level of the luminance is represented by density of hatching pattern. As the density of the hatching pattern is lower (a bright portion), the luminance is higher, and as the density of the hatching pattern is higher (a dark portion), the luminance is lower.

As illustrated in FIG. 9, Comparative Example 1 includes two prism sheets and the front luminance is high. As illustrated in FIG. 10, in Comparative Example 2, light that is dispersed by the wavelength conversion sheet is collected by the prism sheet only with respect to the X-axis direction and is dispersed with respect to the Y-axis direction compared to Comparative Example 1. The front luminance is low. As illustrated in FIG. 11, in the present embodiment, the front luminance similar to that of Comparative Example 1 is obtained. Specifically, in Comparative Example 2, the front luminance is 57.9% of that of Comparative Example 1, and in the present embodiment, the front luminance is 99.4% of that of Comparative Example 1 (see FIG. 8). In the present embodiment, the number of the prism sheets is reduced by one from that of Comparative Example 1 and the front luminance is similar to that of Comparative Example 1. FIG. 8 illustrates the luminance that is obtained when the second prism portion 65 has the apex angle T1 of 90° and the third inclined surface 63 has the inclination angle K1 of 60° in the light guide plate.

### Second Embodiment

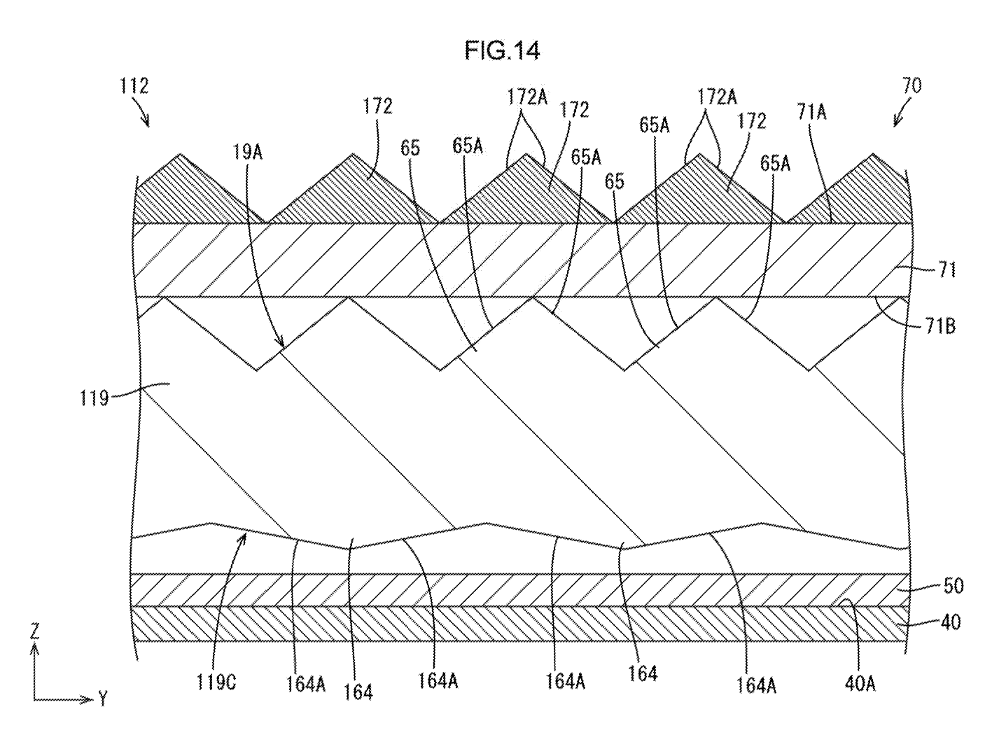

Next, a second embodiment of the present invention will be described with reference to FIGS. 12 to 16. In a backlight device 112 of the present embodiment, configurations of a light guide plate 119 and a prism sheet 170 differ from those of the above embodiment. As illustrated in FIG. 12, the light guide plate 119 includes third prism portions 164 on a light exit surface 119C thereof near the light reflection sheet 40. As illustrated in FIG. 12, the third prism portions 164 extend in the X-axis direction and arranged in the Y-axis direction. As illustrated in FIG. 14, each of the third prism portions 164 has substantially a triangular cross-sectional shape and projects toward the back side (toward the light reflection sheet 40) and includes a pair of inclined surfaces 164A, 164A.

The third prism portions 164 provide anisotropic light collecting action to the light that travels within the light guide plate 19 and reaches the inclined surface 164A, and the anisotropic light collecting action is described as follows. Among the rays of light reaching the inclined surface 164A, the light that is incident on the inclined surface 164A at an angle of incident greater than the critical angle is totally reflected by the inclined surface 164A toward the light exit surface 19A (to be closer to the light exit surface 19A in the Z-axis direction). Among the rays of light reaching the inclined surface 164A, light that is incident on the inclined surface 164A at an angle of incident not greater than the critical angle is refracted by the inclined surface 164A and exits the light guide plate toward the light reflection sheet 40. The light exiting toward the light reflection sheet 40 is reflected by the light reflection sheet 40 and refracted by the inclined surface 164A to be collected with respect to the Y-axis direction and the collected light enters the light guide plate 19. Thus, the third prism portions 164 (the unit light collecting portion) form the light collecting portion that collects light with respect to the Y-axis direction.

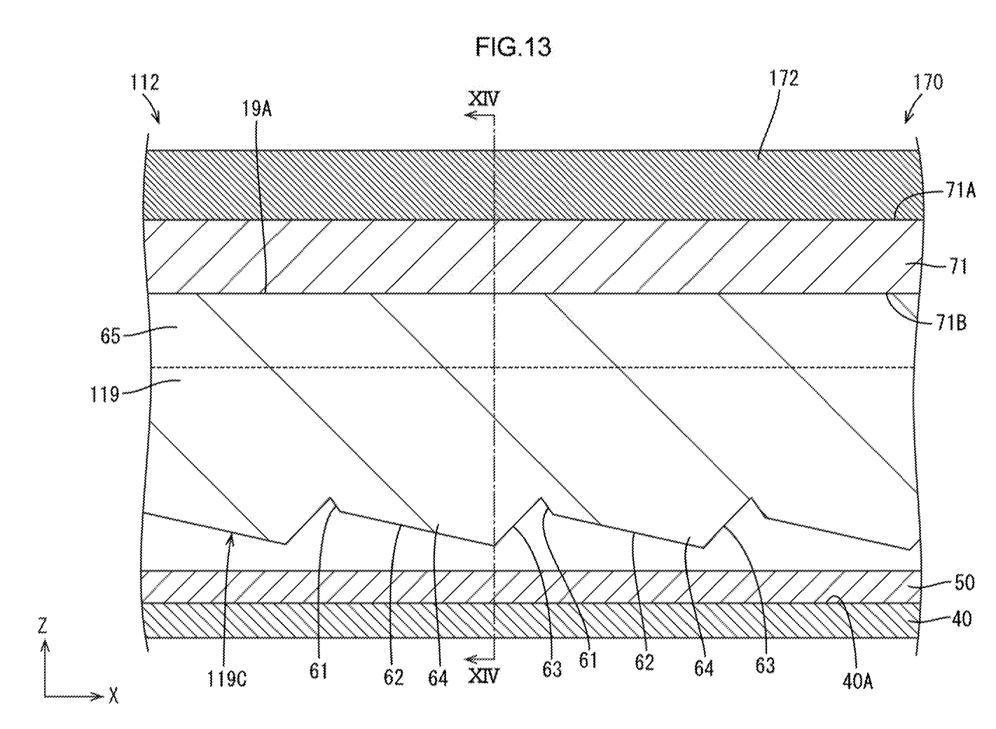

The prism sheet 170 includes a base sheet 71 and prism portions (unit light collecting portions) 172. The prism portions 172 are formed on the light exit-side plate surface 71A of the base sheet 71 and have anisotropic light collecting properties. The prism portions 172 are integrally formed with the light exit-side plate surface 71A of the base sheet 71. The prism portions 172 project from the light exit-side plate surface 71A of the base sheet 71 toward the front side (the light exit side). As illustrated in FIG. 14, each of the prism portions 172 has substantially a triangular cross-sectional shape (substantially a mountain shape) taken in the Y-axis direction and extends linearly in the X-axis direction (see FIG. 13). The prism portions 172 are arranged in the Y-axis direction. Each of the prism portions 172 has a width dimension (in the Y-axis direction) that is constant over an entire length thereof. Each of the prism portions 172 has substantially an isosceles triangular cross-sectional shape and includes a pair of inclined surfaces 172A, 172A.

When the light enters the prism sheet 170 from the light guide plate 119 side, the light is refracted at the light entrance-side plate surface 71B and the light exit-side plate surface 71A of the base sheet 71. The light travelling through the prism portions 172 reaches the sloped surfaces 172A of the prism portions 172. If the angle of incident on the sloped surface 172A is greater than the critical angle, the light is totally reflected by the sloped surface 172A and returned into the base sheet 71 (retroreflection). If the angle of incident on the sloped surface 172A is not greater than the critical angle, the light is refracted by the border surface and exits the prism portion 172. According to the above configuration, the light exiting the prism portions 172 are collected to travel in a front direction (normal direction of the light exit surface 19A) with respect to the Y-axis direction. The second prism portions 65 of the light guide plate 119 are configured to collect light with respect to the Y-axis direction. Namely, the prism sheet 170 is configured to collect light with respect to the same direction as the second prism portions 65 collect light.

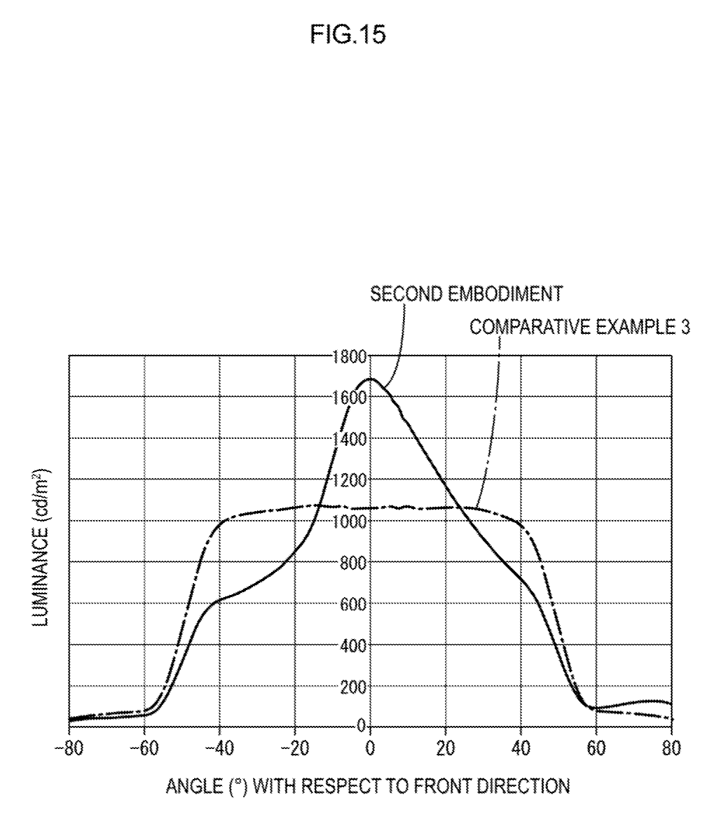

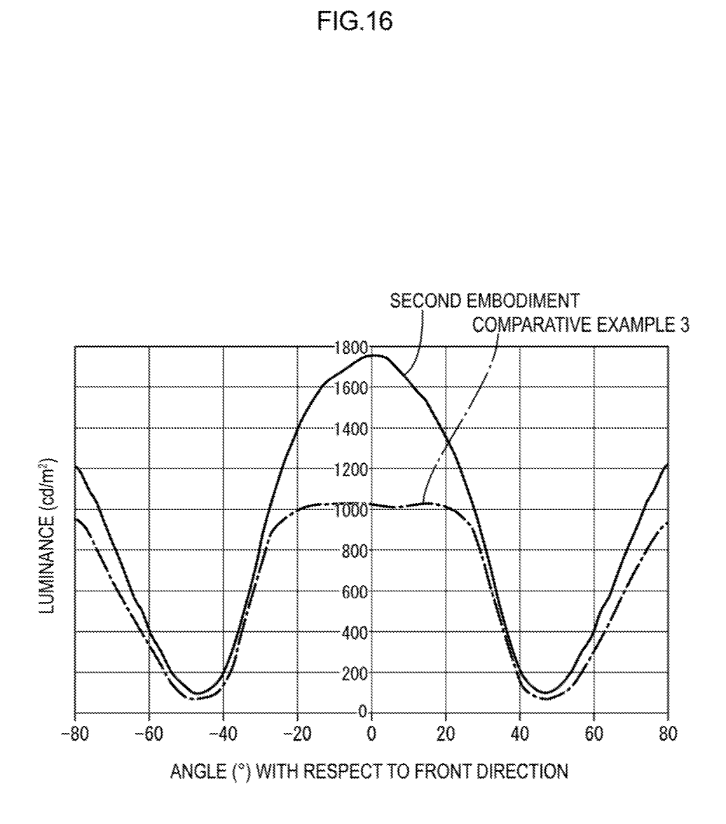

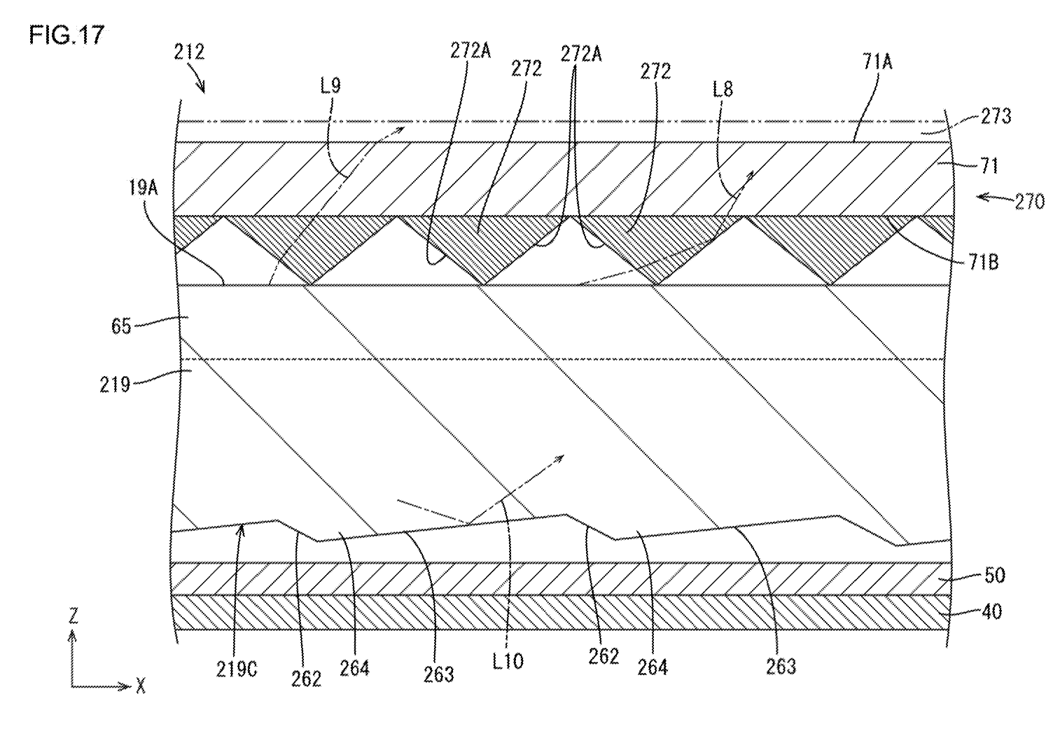

The present embodiment includes the first prism portions 64 for collecting light with respect to the X-axis direction, and the second prism portions 65 and the prism sheet 170 that collect light with respect to the Y-axis direction. According to such a configuration, the front luminance of the exit light from the backlight device is further increased. Such effects will be described with reference to FIGS. 15 and 16. FIGS. 15 and 16 illustrate graphs illustrating luminance of the exit light from the backlight device of the present embodiment and Comparative Example 3. In Comparative Example 3, the wavelength conversion sheet 50 is disposed between the light guide plate 119 and the prism sheet 170. In FIG. 15, a horizontal axis represents an angle (°) in the X-axis direction with respect to the front direction, and a vertical axis represents luminance of exit light. In FIG. 16, a horizontal axis represents an angle (°) in the Y-axis direction with respect to the front direction, and a vertical axis represents luminance of exit light. In FIGS. 15 and 16, a measurement result of the present embodiment is illustrated with a solid line and a measurement result of Comparative Example 3 is illustrated with a dot-and-dash line.

As illustrated in FIG. 15, in comparative Example 3, a great amount of rays of exit light travels in the X-axis direction at an angle range of ±40° with respect to the front direction. In the present embodiment, luminance of exit light increases as is closer in the front direction. As illustrated in FIG. 16, in comparative Example 3, a great amount of rays of exit light travels in the Y-axis direction at an angle range of ±20° with respect to the front direction. According to such a result, a greater amount of light is collected in the Y-axis direction than in the X-axis direction since the light collecting action is provided in the Y-axis direction by the prism sheet 70. In the present embodiment, luminance of exit light especially increases in the angle range of ±20° compared to Comparative Example. Accordingly, in the present embodiment, the exit light is collected in the X-axis direction and the Y-axis direction and the front luminance is higher than that of Comparative Example 3.

In the present embodiment, after the light is collected with respect to the Y-axis direction (the arrangement direction of the LEDs 17) by the third prism portions 164 and the second prism portions 65, the collected light travel toward the prism portions 172. Therefore, a greater amount of light exits the prism portions 172 without having retroreflection at the inclined surfaces 172A of the prism portions 172. Accordingly, light use efficiency is effectively improved and luminance of the exit light from the backlight device 112 is further increased.

### Third Embodiment

Next, a third embodiment of the present invention will be described with reference to FIGS. 17 to 23. In a backlight device 212 of the present embodiment, configurations of a light guide plate 219 and a prism sheet 270 differ from those of the above embodiment. As illustrated in FIG. 17, the light guide plate 219 includes first prism portions 264 on a light exit surface 219C thereof near the light reflection sheet 40. The first prism portions 264 extend in the Y-axis direction and arranged in the X-axis direction. As illustrated in FIG. 14, each of the first prism portions 264 includes a first inclined surface 262 and a second inclined surface 263.

The first inclined surface 262 is inclined to be closer to the light reflection sheet 40 (a lower side in FIG. 17) as is farther away from the LEDs 17 (the light entrance surface 19B) in the X-axis direction. The second inclined surface 263 is inclined to be closer to the light exit surface 19A (an upper side in FIG. 17) as is farther away from the LEDs 17 (the light entrance surface 19B) in the X-axis direction. The second inclined surface 263 is continuous from one end of the first inclined surface 262 (an end portion farther from the LEDs 17). Among the rays of light travelling within the light guide plate 219 and reaching the second inclined surface 263 from the LED 17 side (the left side in FIG. 4), light entering through the second inclined surface 263 at an incident angle not less than the critical angle is totally reflected by the second inclined surface 263 toward the light exit surface 19A (as is represented by an arrow L10 in FIG. 17). The second inclined surface 263 (the inclined surface) is a light collection portion that collects light to travel in the Z-axis direction (in a normal direction of the plate surface of the light guide plate 19, in the plate thickness direction of the light guide plate 219).

The prism sheet 270 includes a base sheet 71 and prism portions 272. The prism portions 272 are integrally formed with the light entrance-side plate surface 71B of the base sheet 71. The prism portions 272 project from the light entrance-side plate surface 71B of the base sheet 71 toward the light exit surface 19A. Each of the prism portions 272 has a triangular cross-sectional shape taken in the X-axis direction and the triangular cross sectional shape narrows as is toward the light exit surface 19A. The prism portions 272 extend linearly in the Y-axis direction (in a direction penetrating through the sheet in FIG. 17) and are arranged in the X-axis direction. Each of the prism portions 272 has a width dimension (in the X-axis direction) that is constant over an entire length thereof. Each of the prism portions 272 has substantially an isosceles triangular cross-sectional shape and includes a pair of inclined surfaces 272A.

Among the rays of light entering the prism portions 272 from the light guide plate 219 side and reaching the inclined surface 272A, light entering through the inclined surface 272A at an incident angle greater than the critical angle is totally reflected by the inclined surface 272A toward the base sheet 71 (as is represented by an arrow L8 in FIG. 17). Accordingly, the light is collected by the prism portions 272 with respect to the X-axis direction. In the configuration of the present embodiment in that the light collecting action is provided with using total reflection by the inclined surface 272A, a part of the rays of exit light through the light exit surface 19A may not be totally reflected (collected) by the inclined surface 272A and may travel in a direction toward the light exit-side plate surface 71A (as is represented by an arrow L9 in FIG. 17).

If the wavelength conversion sheet 50 is disposed between the prism sheet 270 and the light guide plate 219, light that is isotropically scattered by the wavelength conversion sheet 50 is incident directly on the prism sheet 270 and a great amount of light is incident on the prism sheet 70 at an incident angle at which the light is not totally reflected by the inclined surface 272A. In the present embodiment, the light is isotropically scattered by the wavelength conversion sheet 50 and then, the light is collected by the light guide plate 219 and travels toward the prism sheet 270. As a result, the incident angle at which the light is incident on the prism sheet 270 is controlled and light that is not totally reflected (is not collected) by the inclined surface 272A is less likely to generated and the front luminance is less likely to be lowered.

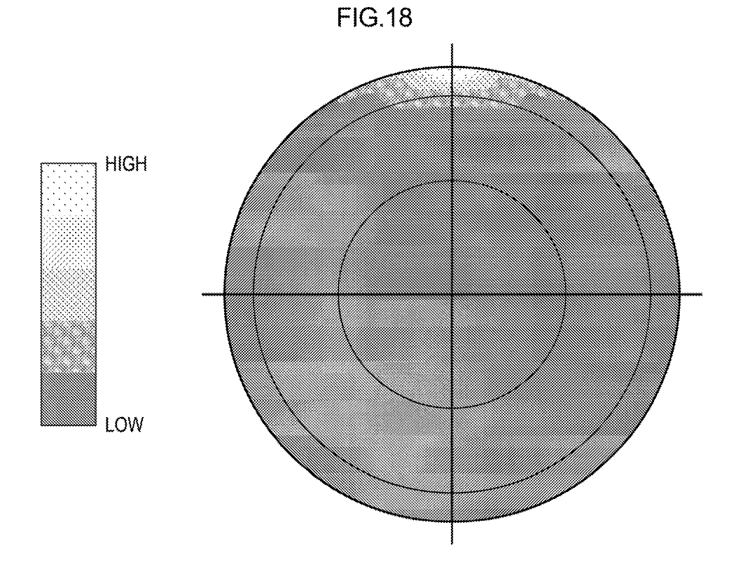

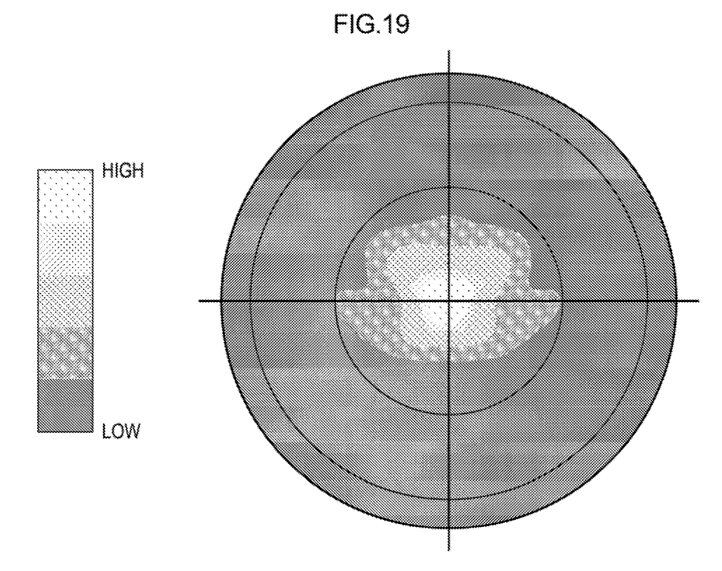

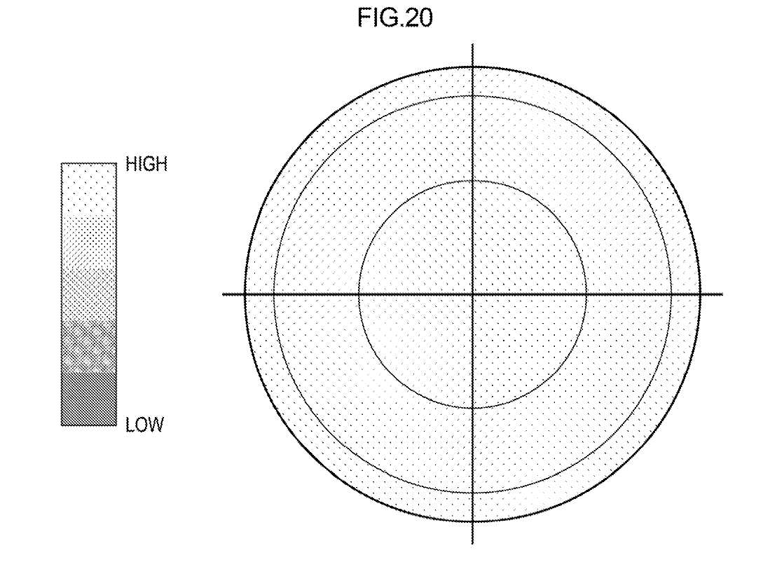

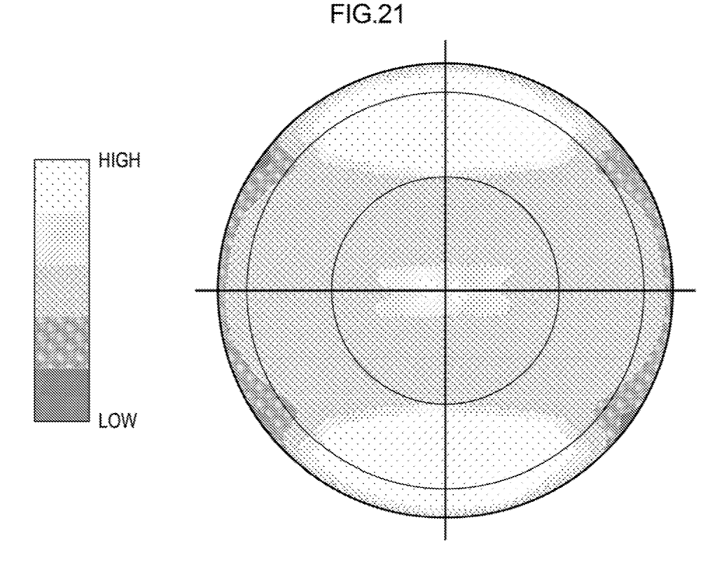

The effects will be described with comparing to Comparative Examples 4 and 5. Comparative Example 4 includes no wavelength conversion sheet 50, and the wavelength conversion sheet 50 is between the prism sheet 270 and the light guide plate 219 in Comparative Example 5. FIGS. 18 to 21 illustrate luminance angle distributions with respect to the front direction as a result of measurement of luminance in the configurations of Comparative Examples 4 and 5. FIG. 18 illustrates a luminance angle distribution of exit light exiting the light guide plate 219 according to Comparative Example 4 (and Comparative Example 5). FIG. 19 illustrates a luminance angle distribution of exit light exiting the prism sheet 270 according to Comparative Example 4. FIG. 20 illustrates a luminance angle distribution of exit light exiting the wavelength conversion sheet 50 according to Comparative Example 5. FIG. 21 illustrates a luminance angle distribution of exit light exiting the prism sheet 270 according to Comparative Example 5.

In FIGS. 18 to 21, a horizontal axis represents an angle of light travelling in the Y-axis direction with reference to the front direction (the Z-axis direction, with the backlight device seen from the front side) and a vertical axis represents an angle of light travelling in the X-axis direction with reference to the front direction. In FIGS. 18 to 21, a level of the luminance is represented by density of hatching pattern. As the density of the hatching pattern is lower (a bright portion), the luminance is higher, and as the density of the hatching pattern is higher (a dark portion), the luminance is lower.

In Comparative Example 4, as illustrated in FIG. 18, the luminance of the exit light from the light guide plate 219 is substantially same with respect to all angles and the front luminance is increased by collecting the light by the prism sheet 270 (see FIG. 19). In Comparative Example 5, as illustrated in FIG. 20, the luminance of the exit light from the wavelength conversion sheet 50 is substantially same with respect to all angles. This means that the light passing through the wavelength conversion sheet 50 is isotropically scattered. Therefore, in Comparative Example 5, the light is effectively collected by the prism sheet 270 with respect to the X-axis direction (the vertical axis in FIG. 21) and the front luminance is lowered (see FIG. 21).

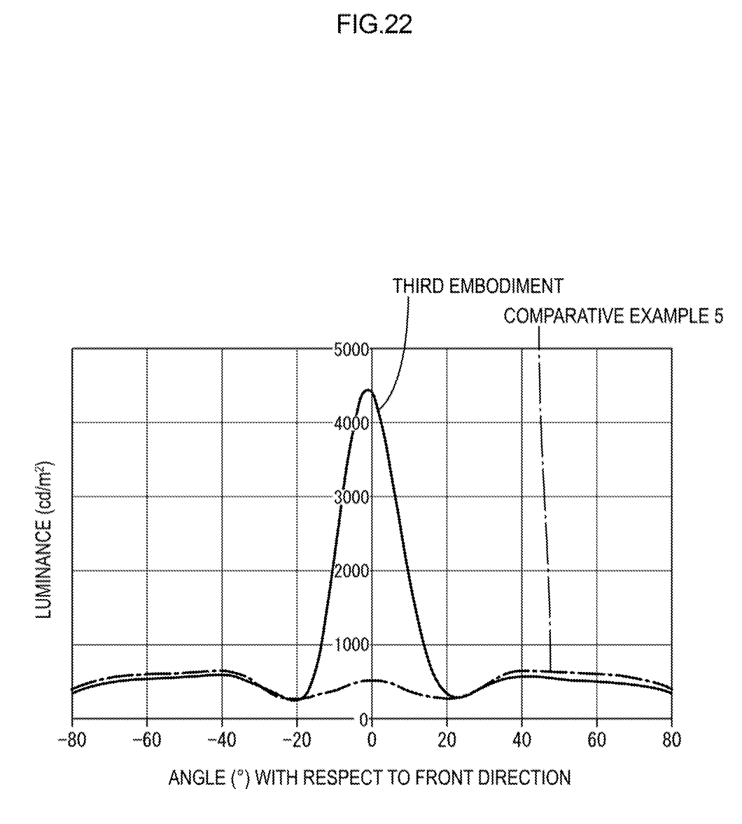

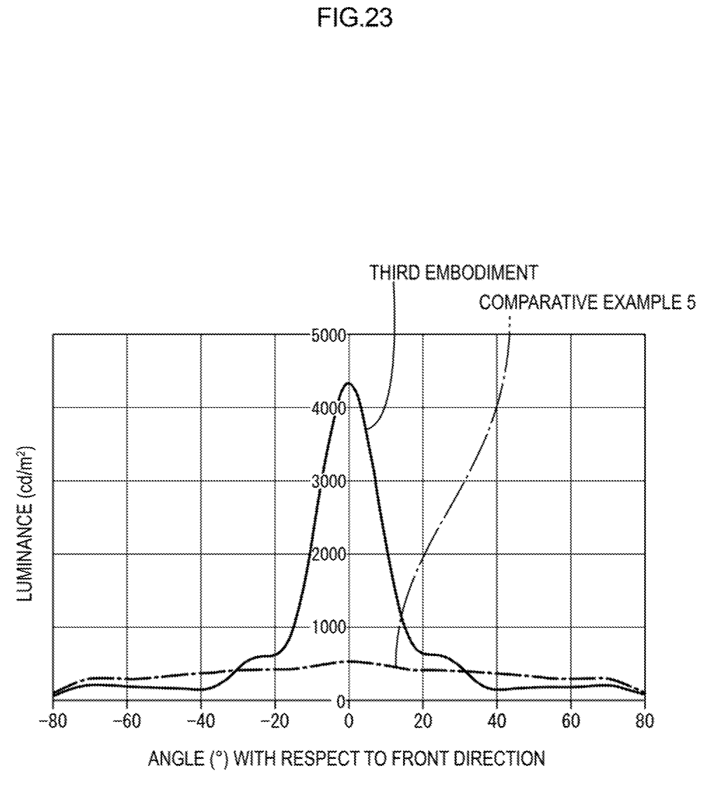

FIGS. 22 and 23 illustrate graphs illustrating luminance of the exit light from the backlight device (the prism sheet 270) of the present embodiment and Comparative Example 5. In FIG. 22, a horizontal axis represents an angle (°) in the X-axis direction with respect to the front direction, and a vertical axis represents luminance of exit light. In FIG. 23, a horizontal axis represents an angle (°) in the Y-axis direction with respect to the front direction, and a vertical axis represents luminance of exit light. In FIGS. 22 and 23, a measurement result of the present embodiment is illustrated with a solid line and a measurement result of Comparative Example 5 is illustrated with a dot-and-dash line. As is illustrated in FIGS. 22 and 23, the exit light in Comparative Example 5 has a luminance distribution similar to Lambert distribution where the light is evenly dispersed in the X-axis direction and in the Y-axis direction and the front luminance is lowered. In the present embodiment, luminance of exit light is especially high in the angle range of ±20° and the front luminance is high.

In the present embodiment, a reflection type polarization sheet 273 (illustrated with two dot chain line in FIG. 17) may be disposed to cover the prism sheet 270. The reflection type polarization sheet 273 has a multiple-layered structure and layers having different refractive index are layered on each other. Among the rays of light exiting the prism sheet 270, p-polarized light passes through the reflection type polarization sheet 273 and s-polarized light is reflected by the reflection type polarization sheet 273 toward the light guide plate 219. The s-polarized light reflected by the reflection type polarization sheet 273 is reflected again by the light reflection sheet 40 toward the front side while passing through the wavelength conversion sheet 50. Accordingly, the great amount of light travels toward the wavelength conversion sheet 50 and greater amount of blue light from the LEDs 17 is converted into green light (and red light). Such a reflection type polarization sheet 273 is preferably included in a configuration in which the exit light from the light guide plate 219 has a less amount of green light and red light and desired white light is not obtained. An example of such a reflection type polarization sheet 273 may be “DBEF” (product made by SUMITOMO 3M Co. Ltd.). The s-polarized light is separated into s-polarized light and p-polarized light when reflected by the light reflection sheet 40. Accordingly, s-polarized light that is absorbed by a polarizing plate of the liquid crystal panel 11 is reflected toward the light guide plate 219 and can be reused. Therefore, light use efficiency (luminance) is increased.

### Fourth Embodiment

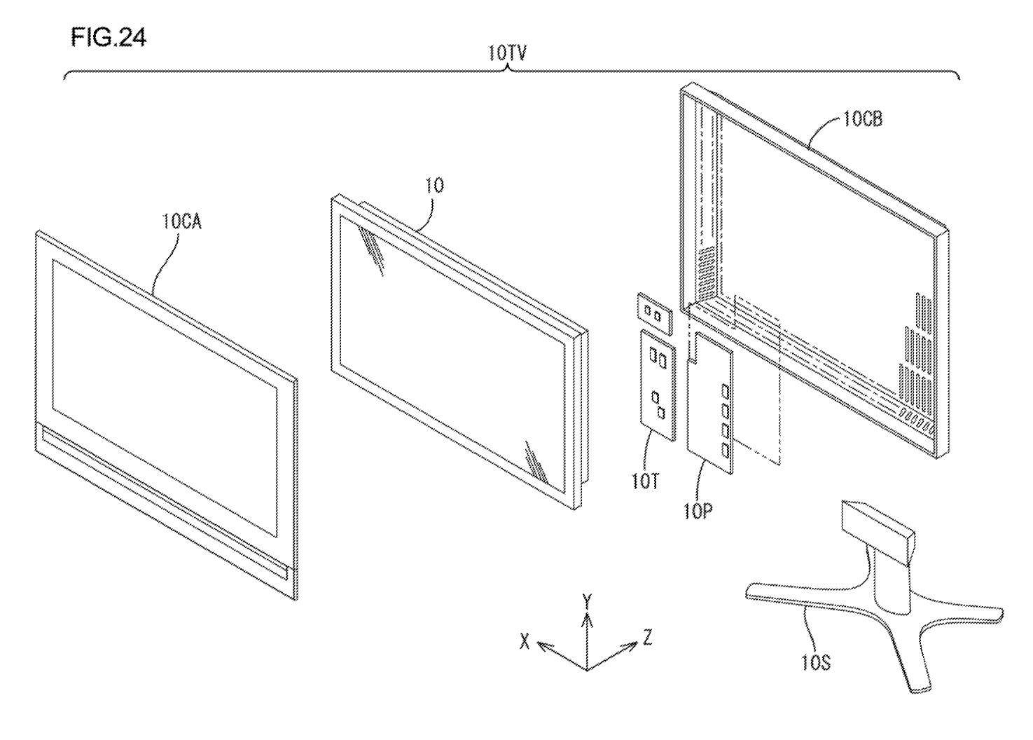

A fourth embodiment of the present invention will be described with reference to FIG. 24. In the present embodiment, a television device 10TV including the liquid crystal display device will be described. As illustrated in FIG. 24, the television device 10TV of the present embodiment includes the liquid crystal display device 10, front and rear cabinets 10Ca, 10CB that sandwich the liquid crystal display device 10 therebetween, a power source 10P, a tuner 10T receiving television signals (a receiver), and a stand 105. The liquid crystal display device 10 has a laterally-elongated rectangular shape as a whole and arranged in a vertical position. The television device 10TV includes the liquid crystal display device 10 that increases the front luminance. Accordingly, television images of good display quality can be displayed.

### Other Embodiments

The present invention is not limited to the embodiments, which have been described using the foregoing descriptions and the drawings. For example, embodiments described below are also included in the technical scope of the present invention.

(1) In each of the above embodiments, the wavelength conversion sheet 50 contains quantum dot phosphor. Other type of phosphors may be contained in each of the phosphor layers. Specifically, for example, sialon phosphor (such as β3-sialon phosphor, and a-sialon phosphor), complex fluoride phosphor (such as manganese-activated potassium silicofluroide (K2TiF6)), CASN phosphor, europium phosphor, selenium phosphor, and YAG phosphor may be used.

(2) The reflection type polarization sheet 273 described in the third embodiment may be included in the configurations of the first and second embodiments.

(3) In the above embodiments, the prism portions are included as the light collecting portion and the light collection portion is not limited thereto. A cylindrical lens may be used as the light collecting portion. The light collecting portion does not necessarily have anisotropy of the prism portion. The light collecting portion may have anisotropy of a semispherical lens.

(4) In the above embodiments, the prism sheet including the prism portions are included as the light collection sheet and it is not limited thereto. For example, the collection sheet may include cylindrical lenses.

(5) In each of the above embodiments, the light collecting portion is included on at least one of the pair of light exit surfaces of the light guide plate (for example, one of the light exit surfaces 19A, 19C) and may be included on only one of them.

(6) In the first and second embodiments, the prism sheet 70 (or 170) includes the prism portions projecting from the light exit-side plate surface 71A of the base sheet 71 toward the front side (the light exit side) and the light is collected by the prism portions of the prism sheet 70 (or 170) with respect to the X-axis direction (or the Y-axis direction). However, the configuration of the prism portions is not limited thereto. For example, the prism portions may project from the light entrance-side plate surface 71B of the base sheet 71 toward the back side and have a triangular shape that is tapered as is closer to the back side. Light may be collected by such prism portions with respect to the X-axis direction (or the Y-axis direction).

(7) In each of the embodiments, the LEDs are used as the light source. However, other light sources such as an organic EL may be used.

(8) In each of the above embodiments, the TFTs are used as switching components of the liquid crystal display device. However, switching components other than the TFTs (such as thin film diodes (TFDs)) may be included in the scope of the present invention. Furthermore, a liquid crystal display device configured to display black and white images other than the liquid crystal display device configured to display color images.

(9) In each of the above embodiments, the liquid crystal display device including the liquid crystal panel as the display panel is used. The present invention may be applied to display devices including other type of display panel.

(10) In the third embodiment, the television device including the tuner is included. However, a display device without including a tuner may be included in the scope of the present invention. Specifically, the present invention may be applied to liquid crystal display devices used as digital signage or an electronic blackboard.

### EXPLANATION OF SYMBOLS

10: liquid crystal display device (display device), 10TV: television device, 11: liquid crystal panel (display panel), 12, 112, 212: backlight device (lighting device), 17: LED (light source), 19: light guide plate, 19A: light exit surface (one of a pair of light exit surfaces not being covered with a light reflecting member), 19B: light entrance surface, 19C, 119C, 219C: light exit surface, 40: light reflection sheet (light reflecting member), 50: wavelength conversion sheet (wavelength conversion member), 63: third inclined surface (inclined surface), 65: second prism portion (unit light collecting portion, light collecting portion), 164: third prism portion (unit light collecting portion, light collecting portion), 270: prism sheet (light collecting sheet), 272: prism portion

1. A lighting device comprising:
light sources;
a light guide plate including an edge surface and a pair of plate surfaces, a part of the edge surface being a light entrance surface through which light from the light sources enters, and the pair of plate surfaces being light exit surfaces through which the light exits, the light guide plate including a light collecting portion that is formed on one of the pair of plate surfaces and configured to collect light in a direction of a normal line of the one of the pair of plate surfaces;
a light reflecting member that is disposed to cover the one of the pair of plate surfaces or another one of the pair of plate surfaces and configured to reflect the light toward the light guide plate; and
a wavelength conversion member disposed between the light guide plate and the light reflecting member and converting a wavelength of light transmitting therethrough.

2. The lighting device according to claim 1, wherein
the light guide plate has a rectangular shape and the light entrance surface has an elongated shape extending in one side direction of the light guide plate,
the light sources are arranged in an elongated direction of the light entrance surface, and the light collecting portion collects light with respect to an arrangement direction in which the light sources are arranged.

3. The lighting device according to claim 2, wherein the light collecting portion includes unit light collecting portions that extend in another side direction of the light guide plate and are arranged in the one side direction.

4. The lighting device according to claim 1, wherein
one of the pair of light exit surfaces that is covered with the light reflection portion has inclined surfaces each of which is inclined toward another one of the pair of light exit surfaces that is not covered with the light reflection portion as is farther away from the light sources, and
the inclined surfaces are arranged in a direction farther away from the light sources.

5. The lighting device according to claim 4, wherein the inclined surfaces have a greater area as is farther away from the light sources.

6. The lighting device according to claim 1, further comprising a light collecting sheet provided to cover one of the pair of light exit surfaces that is not covered with the light reflecting member and configured to collect light to travel in a direction of a normal line of the one of the pair of light exit surfaces.

7. The lighting device according to claim 6, wherein the light collecting sheet is configured to collect light in a direction along the plate surfaces of the light guide plate and with respect to a direction perpendicular to a light collection direction of the light collection portion.

8. The lighting device according to claim 6, wherein
the light collecting sheet is a prism sheet including prism portions, and each of the prism portions has a triangular cross-sectional shape that narrows toward the light exit surface that is not covered with the light reflecting member.

9. A display device comprising:
the lighting device according to claim 1; and
a display panel displaying images using light from the lighting device.

10. The display device according to claim 9, wherein the display panel is a liquid crystal panel including a pair of substrates and liquid crystals enclosed between the substrates.

11. A television device comprising the display device according to claim 9.
